(19) United States
(12) Patent Application Publication
(10) Pub. No.: US 2025/0089120 A1
(43) Pub. Date: Mar. 13, 2025

(54) METHOD OF CONFIGURING AND INDICATING TERMINAL BEAM INFORMATION THROUGH COMMON TCI FOR MULTI-TRANSCEIVER COMMUNICATION ENVIRONMENT IN WIRELESS COMMUNICATION SYSTEM

(71) Applicant: Samsung Electronics Co., Ltd., Suwon-si, Gyeonggi-do (KR)

(72) Inventors: Kyoungmin PARK, Suwon-si (KR); Ameha Tsegaye ABEBE, Suwon-si (KR); Seongmok LIM, Suwon-si (KR); Youngrok JANG, Suwon-si (KR); Hyoungju JI, Suwon-si (KR)

(21) Appl. No.: 18/728,326

(22) PCT Filed: Jan. 13, 2023
(86) PCT No.: PCT/KR2023/000657

§ 371 Date: Jul. 11, 2024

(30) Foreign Application Priority Data
Jan. 27, 2022 (KR) 10-2022-0012423

(51) Int. Cl. H04W 76/20; H04L 5/00; H04W 16/28; H04W 72/231

(52) U.S. Cl. CPC H04W 76/20; H04L 5/0044; H04W 16/28; H04W 72/231

(57) ABSTRACT

The present disclosure relates to a 5G or 6G communication system for supporting higher data transfer rates. The present disclosure provides a method of providing transmission configuration indicator (TCI) state information for beam control of a terminal by a base station, the method comprising the steps of: transmitting DCI including TCI index information to a terminal; and receiving, from the terminal, a predetermined channel on the basis of a beam controlled on the basis of TCI state information corresponding to the TCI index information, wherein the TCI state information comprises information relating to at least one of a target channel and a target reference signal (RS) to be subjected to beam control on the basis of the TCI state information.

### CROSS-REFERENCE TO RELATED APPLICATION(S)

This application is a U.S. National Stage application under 35 U.S.C. § 371 of an International application number PCT/KR2023/000657, filed on Jan. 13, 2023, which is based on and claims priority of a Korean patent application number 10-2022-0012423, filed on Jan. 27, 2022, in the Korean Intellectual Property Office, the disclosure of which is incorporated by reference herein in its entirety.

### TECHNICAL FIELD

The disclosure relates to operations of a base station and a terminal in a wireless communication system and, particularly, to a method and an apparatus for controlling a beam in a wireless communication system.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services, in particular, ways to efficiently provide a beam control technique for communication through multiple transmission/reception nodes.

### DISCLOSURE OF INVENTION

### Technical Problem

The disclosed embodiment is to provide a device and a method capable of effectively providing a service in a wireless communication system.

### Solution to Problem

According to an embodiment of the disclosure, a method of providing transmission configuration indicator (TCI) state information for beam control of a terminal by a base station may include: transmitting DCI including TCI index information to the terminal; and transmitting a predetermined channel from the terminal, based on a beam controlled based on TCI state information corresponding to the TCI index information, wherein the TCI state information includes information on at least one of a target channel and a target reference signal (RS) on which beam control is to be performed based on the TCI state information.

According to an embodiment of the disclosure, the TCI state information may be applied to beam control of another channel or another RS other than the target channel or the target RS according to a configuration of the base station.

According to an embodiment of the disclosure, the method may further include providing, to the terminal, information on a relationship between at least one of the target channel or the target RS and at least one of another channel or another RS.

According to an embodiment of the disclosure, TCI state information in which a first control channel or a demodulation reference signal (DMRS) of the first control channel is configured as the target channel or the target RS may also be used for beam control of a second control channel or a DMRS of the second control channel.

According to an embodiment of the disclosure, the TCI index information may include first TCI state information and second TCI state information.

According to an embodiment of the disclosure, in case that the first TCI state information is applicable to beam control of a first channel, and the second TCI state information is not applicable to beam control of the first channel, the base station is unable to configure the terminal to receive the first channel from multiple base stations.

According to an embodiment of the disclosure, in case that the first TCI state information and the second TCI state information are applicable to beam control of a first channel, the base station is able to configure the terminal to receive the first channel from multiple base stations.

According to an embodiment of the disclosure, the TCI state information may be configured for each control resource set (CORESET).

According to an embodiment of the disclosure, a method of obtaining transmission configuration indicator (TCI) state information for beam control of a terminal may include: receiving DCI including TCI index information from a base station; controlling a beam for receiving a predetermined channel, based on TCI state information corresponding to the TCI index information; and receiving the predetermined channel through the controlled beam, wherein the TCI state information includes information on at least one of a target channel and a target reference signal (RS) on which beam control is to be performed based on the TCI state information.

According to an embodiment of the disclosure, the TCI index information may include first TCI state information and second TCI state information.

According to an embodiment of the disclosure, the TCI state information may be applied to beam control of another channel or another RS other than the target channel or the target RS according to a configuration of the base station.

According to an embodiment of the disclosure, the method may further include receiving, from the base station, information on a relationship between at least one of the target channel or the target RS and at least one of another channel or another RS.

According to an embodiment of the disclosure, the TCI state information may be configured for each control resource set (CORESET).

According to an embodiment of the disclosure, a base station for providing transmission configuration indicator (TCI) state information for beam control of a terminal may include: a transceiver; and a processor coupled to the transceiver and configured to transmit DCI including TCI index information to the terminal, and transmit a predetermined channel from the terminal, based on a beam controlled based on TCI state information corresponding to the TCI index information, wherein the TCI state information includes information on at least one of a target channel and a target reference signal (RS) on which beam control is to be performed based on the TCI state information.

According to an embodiment of the disclosure, a terminal for obtaining transmission configuration indicator (TCI) state information for beam control may include: a transceiver; and a processor coupled to the transceiver and configured to receive DCI including TCI index information from a base station, control a beam for receiving a predetermined channel, based on TCI state information corresponding to the TCI index information, and receive the predetermined channel through the controlled beam, wherein the TCI state information includes information on at least one of a target channel and a target reference signal (RS) on which beam control is to be performed based on the TCI state information.

### Advantageous Effects of Invention

The disclosed embodiment provides a device and a method capable of effectively providing a service in a wireless communication system.

### BRIEF DESCRIPTION OF DRAWINGS

FIG. 1 illustrates a basic structure of a time-frequency domain in a wireless communication system according to an embodiment of the disclosure.

FIG. 2 illustrates a structure of a frame, a subframe, and a slot in a wireless communication system according to an embodiment of the disclosure.

FIG. 3 illustrates an example of bandwidth part configuration in a wireless communication system according to an embodiment of the disclosure.

FIG. 4 illustrates an example of control resource set configuration of a downlink control channel in a wireless communication system according to an embodiment of the disclosure.

FIG. 5A illustrates a structure of a downlink control channel in a wireless communication system according to an embodiment of the disclosure.

FIG. 5B illustrates, in terms of spans, a case in which a UE may have multiple PDCCH monitoring occasions inside a slot in a wireless communication system according to an embodiment of the disclosure.

FIG. 6 illustrates an example of a DRX operation in a wireless communication system according to an embodiment of the disclosure.

FIG. 7 illustrates an example of base station beam allocation according to TCI state configuration in a wireless communication system according to an embodiment of the disclosure.

FIG. 8 illustrates an example of a method for allocating a TCI state to a PDCCH in a wireless communication system according to an embodiment of the disclosure.

FIG. 9 illustrates a TCI indication MAC CE signaling structure for a PDCCH DMRS in a wireless communication system according to an embodiment of the disclosure.

FIG. 10 illustrates an example of beam configuration with regard to a control resource set and a search space in a wireless communication system according to an embodiment of the disclosure.

FIG. 11 illustrates a method in which a base station and a UE transmit/receive data in consideration of a downlink data channel and a rate matching resource in a wireless communication system according to an embodiment of the disclosure.

FIG. 12 illustrates a method in which, upon receiving a downlink control channel, a UE selects a receivable control resource set in consideration of priority in a wireless communication system according to an embodiment of the disclosure.

FIG. 13 illustrates an example of frequency domain resource allocation with regard to a PDSCH in a wireless communication system according to an embodiment of the disclosure.

FIG. 14 illustrates an example of time domain resource allocation with regard to a PDSCH in a wireless communication system according to an embodiment of the disclosure.

FIG. 15 illustrates an example of time domain resource allocation according to a subcarrier spacing with regard to a data channel and a control channel in a wireless communication system according to an embodiment of the disclosure.

FIG. 16 illustrates an example of a process for beam configuration and activation with regard to a PDSCH.

FIG. 17 illustrates PUSCH repeated transmission type B in a wireless communication system according to an embodiment of the disclosure.

FIG. 18 illustrates a scheme for controlling a transmission and reception beam of a channel or a signal based on a common TCI state according to an embodiment of the disclosure;

FIG. 19 illustrates a method of providing information on multiple beams through multiple pieces of TCI information according to an embodiment of the disclosure;

FIG. 20 illustrates a method of configuring a channel to which a common TCI state is applied, according to an embodiment of the disclosure;

FIG. 21 illustrates a method of configuring a channel to which a common TCI state is applied, according to an embodiment of the disclosure;

FIG. 22 illustrates a scheme for configuring a TCI index and a TCI State according to an embodiment of the disclosure;

FIG. 23 illustrates a beam and TRP indication method by a terminal operating in an m-TRP system, according to an embodiment of the disclosure;

FIG. 24 illustrates a scheme for configuring a TCI index and a TCI State according to an embodiment of the disclosure;

FIG. 25 illustrates a beam and TRP indication method by a terminal operating in an m-TRP system, according to an embodiment of the disclosure;

FIG. 26 illustrates an operation of a terminal according to an embodiment of the disclosure; and

FIG. 27 illustrates an operation of a base station according to an embodiment of the disclosure.

FIG. 29 illustrates a structure of a UE according to an embodiment of the disclosure.

FIG. 30 illustrates a structure of a base station according to an embodiment of the disclosure.

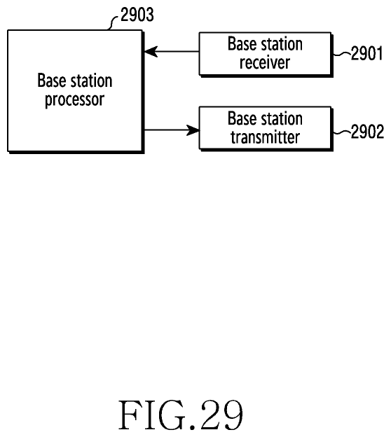

### MODE FOR CARRYING OUT THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. The contents of the disclosure may be applied to FDD and TDD systems.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Of course, mMTC, URLLC, and eMBB as described above are merely examples of different types of services, and service types to which the disclosure is applicable are not limited to the above examples.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

Among these services, the URLLC service is a service that is newly considered in the 5G system, in contrast to the existing 4G system, and requires to meet ultrahigh reliability (e.g., packet error rate of about 10-5) and low latency (e.g., about 0.5 msec) conditions as compared to the other services. To meet these strict conditions required therefor, the URLLC service may need to apply a shorter transmission time interval (TTI) than the eMBB service, and various operating schemes employing the same are now under consideration.

A multiple transmission and reception node technique (multiple transmission and reception point, M-TRP) in which a UE performs communication through multiple transmission and reception nodes has been standardized through 3GPP Rel-16 as a common scheme for satisfying conflicting requirements between a URLLC service requiring high reliability and an eMBB service requiring a high transmission rate and, thereafter, a method of applying the technology to various channels, such as a PDCCH, a PDSCH, a PUSCH, and a PUCCH has been presented through Rel-17. The M-TRP technique is divided into two techniques, such as a single control information technique (single downlink control information, hereinafter, referred to as S-DCI) for controlling transmission and reception through multiple nodes through one piece of control information and a multiple control information technique (multiple downlink control information, hereinafter, referred to as M-DCI) for separately transmitting information on respective nodes. The S-DCI technique is a technique suitable to be implemented in a network having a relatively simple structure in which only one of multiple nodes performs UE control, and is also a technique suitable to be used by a cell and a base station responsible for performing communication in a small area. On the other hand, it is expected that the M-DCI technique used in a situation in which multiple nodes perform UE control will be mainly used in a network which provides communication in a relatively wide area and in which a distance between the respective nodes is great.

The disclosure proposes a beam control technique in a case where a UE connected to a network operating based on a common beam performs communication through multiple transmission and reception nodes. In addition, a method of rapidly changing an access mode according to control information through single/multiple inter-node communication is proposed, and a method of simultaneously changing a beam and an access mode is also proposed.

The technical subjects pursued in the disclosure may not be limited to the above-mentioned technical subjects, and other technical subjects which are not mentioned may be clearly understood from the following descriptions by those skilled in the art to which the disclosure pertains.

According to an embodiment of the disclosure, in the case of performing beam control of communication between multiple transmission and reception nodes and a UE, the amount of control information used for beam control and the number of transmissions of control information may be reduced through a configuration and an indication of a common beam. In addition, an m-TRP mode for each channel or a TRP for performing communication for each channel may be differently configured through a scheme of differently allocating a target channel of each TCI state indicating a common beam.

Advantageous effects obtainable from the disclosure may not be limited to the above-mentioned effects, and other effects which are not mentioned may be clearly understood from the following descriptions by those skilled in the art to which the disclosure pertains.

### [NR Time-Frequency Resources]

Hereinafter, a frame structure of a 5G system will be described in more detail with reference to the accompanying drawings.

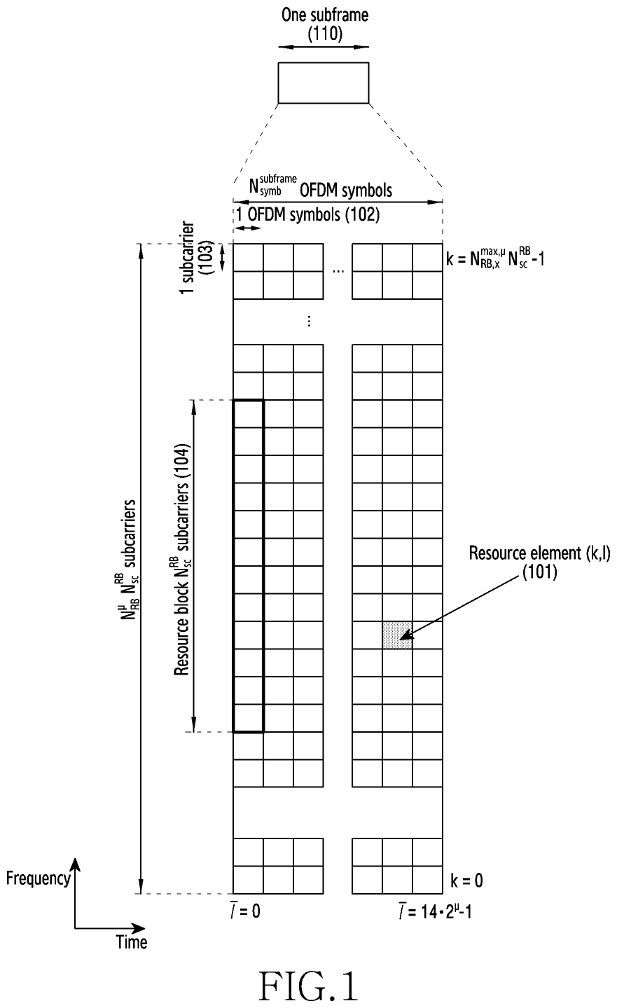

FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104.

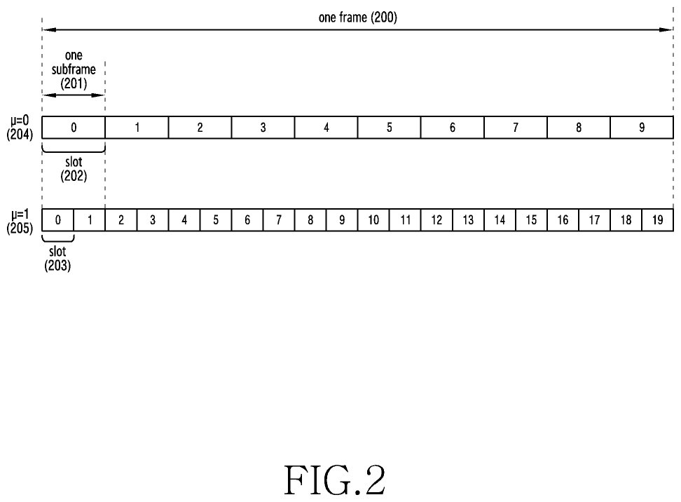

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values p for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe Nₛₗₒₜ^{subframe,μ} may differ depending on the subcarrier spacing configuration value p, and the number of slots per one frame Nₛₗₒₜ^{frame,μ} may differ accordingly. Nₛₗₒₜ^{subframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, bandwidth part (BWP) configuration in a 5G communication system will be described in detail with reference to the accompanying drawings.

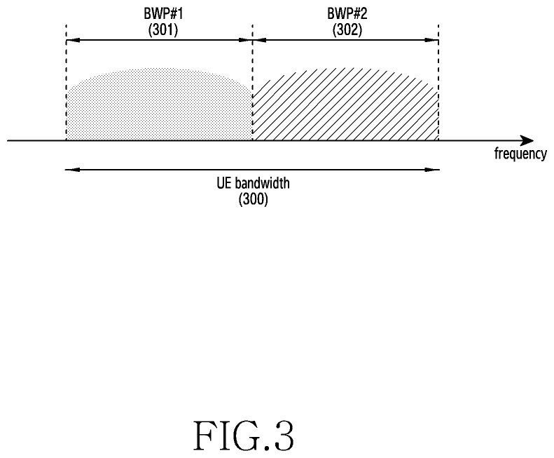

FIG. 3 illustrates an example of bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |

| | |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, n2, n3, n4, n5}, |
| (subcarrier spacing) | |
| cyclicPrefix | ENUMERATED { extended } |
| (cyclic prefix) | |
| } | |

Of course, the bandwidth part configuration is not limited to the above example in Table 2, and in addition to the configuration information in Table 2, various parameters related to the bandwidth part may be configured for the UE. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

According to various embodiments of the disclosure, the bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

According to an embodiment, in connection with the bandwidth part configuring method, UEs, before RRC-connected, may receive configuration information regarding the initial bandwidth part (initial BWP) through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (TBWP) required during a bandwidth part change are specified in standards, and may be defined given in Table 3 below, for example. Obviously, the example given below is not limiting.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. According to an embodiment, if the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [SS/PBCH Block]

Next, synchronization signal (SS)/PBCH blocks in 5G will be described.

An SS/PBCH block may refer to a physical layer channel block including a primary synchronization signal (PSS), a secondary synchronization signal (SSS), and a PBCH. Details thereof are as follows.

PSS: a signal which becomes a reference of downlink time/frequency synchronization, and provides partial information of a cell ID.

SSS: becomes a reference of downlink time/frequency synchronization, and provides remaining cell ID information not provided by the PSS. Additionally, the SSS may serve as a reference signal for PBCH demodulation of a PBCH.

PBCH: provides an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.

SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [DRX]

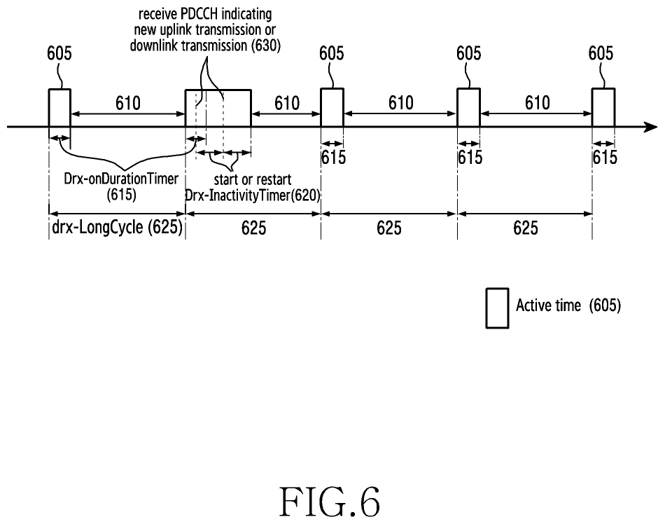

FIG. 6 illustrates discontinuous reception (DRX).

DRX refers to an operation in which a UE currently using a service discontinuously receives data in an RRC-connected state in which a radio link is configured between the base station and the UE. If the DRX is applied, the UE may turn on a receiver at a specific timepoint so as to monitor a control channel, and may turn off the receiver if there is no data received for a predetermined period of time, thereby reducing power consumed by the UE. The DRX operation may be controlled by a MAC layer device, based on various parameters and timers.

Referring to FIG. 6, the active time 605 refers to a time during which the UE wakes up at each DRX cycle and monitors the PDCCH. The active timer 605 may be defined as follows.
drx-onDurationTimer or drx-InactivityTimer or drx-RetransmissionTimerDL or drx-RetransmissionTimerUL or ra-ContentionResolutionTimer is running; or
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity among the contention-based Random Access Preamble
drx-onDurationTimer, drx-InactivityTimer, drx-RetransmissionTimerDL, drx-RetransmissionTimerUL, ra-ContentionResolutionTimer, and the like are timers having values configured by the base station, and may include functions which configure the UE to monitor the PDCCH in a situation in which a predetermined condition is satisfied.
drx-onDurationTimer 615 is a parameter for configuring the minimum time during which the UE is awake at the DRX cycle. drx-InactivityTimer 620 is a parameter for configuring a time during which the UE is additionally awake upon receiving a PDCCH indicating new uplink transmission or downlink transmission (630). drx-RetransmissionTimerDL is a parameter for configuring the maximum time during which the UE is awake in order to receive downlink retransmission in a downlink HARQ procedure. drx-RetransmissionTimerUL is a parameter for configuring the maximum time during which the UE is awake in order to receive an uplink retransmission grant in an uplink HARQ procedure. drx-onDurationTimer, drx-InactivityTimer, drx-RetransmissionTimerDL, and drx-RetransmissionTimerUL may be configured as, for example, time, the number of subframes, the number of slots, and the like. ra-ContentionResolutionTimer is a parameter for monitoring the PDCCH in a random access procedure.
inActive time 610 refers to a time configured such that the PDCCH is not monitored during the DRX operation or a time configured such that the PDCCH is not received, and the inActive time 610 may be obtained by subtracting the active timer 605 from the entire time during which the DRX operation is performed. If the UE does not monitor the PDCCH during the active time 605, the UE may enter a sleep or inActive state, thereby reducing power consumption.

The DRX cycle may refer to the cycle at which the UE wakes up and monitors the PDCCH. That is, the DRX cycle refers to the time interval between when the UE monitors a PDCCH and when the next PDCCH is monitored, or the cycle at which on-duration occurs. There are two kinds of DRX cycles: a short DRX cycle and a long DRX cycle. The short DRX cycle may be optionally applied.

The long DRX cycle 625 is the longer cycle between two DRX cycles configured for the UE. While operating with long DRX, the UE restarts the drx-onDurationTimer 615 at a timepoint at which the long DRX cycle 625 has elapsed from the start point (for example, start symbol) of the drx-onDurationTimer 615. If operating at the long DRX cycle 625, the UE may start the drx-onDurationTimer 615 in a slot after drx-SlotOffset in a subframe satisfying Equation 1 below. Here, drx-SlotOffset may refer to a delay before the drx-onDurationTimer 615 is started. The drx-SlotOffset may be configured, for example, as time, the number of slots, or the like.

$$[ ( SFN X 10 ) + subframe number ] modulo ( drx - LongCycle ) = drx - StartOffset \qquad Equation 1$$

wherein drx-LongCycleStartOffset may be used to define the long DRX cycle 625, and drx-StartOffset may be used to define a subframe to start the long DRX cycle 625. drx-LongCycleStartOffset may be configured as, for example, time, the number of subframes, the number of slots, or the like.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) may be transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through or on a physical downlink control channel (PDCCH). A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example. Obviously, the example given below is not limiting.

```
TABLE 4
  -  Identifier for DCI formats - [1] bit
  -  Frequency domain resource assignment -[┌log₂ (N_{RB}^{UL,BWP}
(N_{RB}^{UL,BWP} + 1)/2┐] bits
  -  Time domain resource assignment - X bits
  -  Frequency hopping flag - 1 bit.
  -  Modulation and coding scheme - 5 bits
  -  New data indicator - 1 bit
  -  Redundancy version - 2 bits
  -  HARQ process number - 4 bits
  -  Transmit power control (TPC) command for scheduled PUSCH -
[2] bits
  -  Uplink/ supplementary uplink (UL/SUL) indicator - 0 or 1 bit
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example. Obviously, the example given below is not limiting.

```
TABLE 5
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
    * For resource allocation type 0, ┌N_{RB}^{UL,BWP}/P┐ bits
    * For resource allocation type 1, ┌log₂(N_{RB}^{UL,BWP}(N_{RB}^{UL,BWP} + 1)/2)┐
    bits
  Time domain resource assignment -1, 2, 3, or 4 bits
  Virtual resource block (VRB)-to-physical resource block (PRB)
mapping - 0 or 1 bit, only for resource allocation type 1.
    * 0 bit if only resource allocation type 0 is configured;
    * 1 bit otherwise.
  Frequency hopping flag - 0 or 1 bit, only for resource allocation type 1.
    * 0 bit if only resource allocation type 0 is configured;
    * 1 bit otherwise.
  Modulation and coding scheme - 5 bits
  New data indicator - 1 bit
  Redundancy version - 2 bits
  HARQ process number - 4 bits
  1st downlink assignment index- 1 or 2 bits
    * 1 bit for semi-static HARQ-ACK codebook;
    * 2 bits for dynamic HARQ-ACK codebook with single HARQ-
    ACK codebook.
  2nd downlink assignment index - 0 or 2 bits
    * 2 bits for dynamic HARQ-ACK codebook with two HARQ-ACK
    sub-codebooks;
    * 0 bit otherwise.
  TPC command for scheduled PUSCH - 2 bits
  $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{S R S} ) ⌉ bits$
    $* ⌈ {log}_{2} ( {\sum }_{k = 1}^{{L}_{max}} ( \begin{matrix}{N}_{S R S} \\ k\end{matrix} ) ) ⌉ bits for non - codebook based PUSCH$
    transmission;
    * ┌log₂(N_{SRS})┐ bits for codebook based PUSCH transmission.
  Precoding information and number of layers - up to 6 bits
  Antenna ports - up to 5 bits
  SRS request - 2 bits
  Channel state information (CSI) request - 0, 1, 2, 3, 4, 5, or 6 bits
  Code block group (CBG) transmission information - 0, 2, 4, 6, or 8 bits
  Phase tracking reference signal (PTRS)-demodulation reference signal
(DDMRS) association - 0 or 2 bits.
  beta_offset indicator - 0 or 2 bits
  DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example. Obviously, the example given below is not limiting.

TABLE 6
- Identifier for DCI formats - [1] bit
- Frequency domain resource assignment - [┌log₂ (N_{RB}^{DL,BWP}
- (N_{RB}^{DL,BWP} + 1)/ 2)┐] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- Pysical uplink control channel (PUCCH) resource indicator - 3 bits
- PDSCH-to-HARQ feedback timing indicator - [3] bits

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example. Obviously, the example given below is not limiting.

```
TABLE 7
  -  Carrier indicator - 0 or 3 bits
  -  Identifier for DCI formats - [1] bits
  -  Bandwidth part indicator - 0, 1 or 2 bits
  -  Frequency domain resource assignment
            * For resource allocation type 0, ┌_{RB}^{DL,BWP} / P┐ bits
            * For resource allocation type 1, ┌log₂ (N_{RB}^{DL,BWP} (N_{RB}^{DL,BWP} + 1)/ 2)┐ bits
  -  Time domain resource assignment -1, 2, 3, or 4 bits
  -  VRB-to-PRB mapping - 0 or 1 bit, only for resource allocation type 1.
            * 0 bit if only resource allocation type 0 is configured;
            * 1 bit otherwise.
  -  Physical resource block (PRB) bundling size indicator - 0 or 1 bit
  -  Rate matching indicator - 0, 1, or 2 bits
  -  Zero power (ZP) channel state information (CSI)-reference signal (RS)
trigger - 0, 1, or 2 bits
  For transport block 1:
  -  Modulation and coding scheme - 5 bits
  -  New data indicator - 1 bit
  -  Redundancy version - 2 bits
  For transport block 2:
  -  Modulation and coding scheme - 5 bits
  -  New data indicator - 1 bit
  -  Redundancy version - 2 bits
  -  HARQ process number - 4 bits
  -  Downlink assignment index - 0 or 2 or 4 bits
  -  TPC command for scheduled PUCCH - 2 bits
  -  PUCCH resource indicator - 3 bits
  -  PDSCH-to-HARQ feedback timing indicator - 3 bits
  -  Antenna ports - 4, 5 or 6 bits
  -  Transmission configuration indication - 0 or 3 bits
  -  SRS request - 2 bits
  -  CBG transmission information - 0, 2, 4, 6, or 8 bits
  -  CBG flushing out information - 0 or 1 bit
  -  DMRS sequence initialization - 1 bit
```

### [PDCCH: CORESET, REG, CCE, and Search Space]

Hereinafter, a downlink control channel in a 5G communication system will be described in more detail with reference to the accompanying drawings.

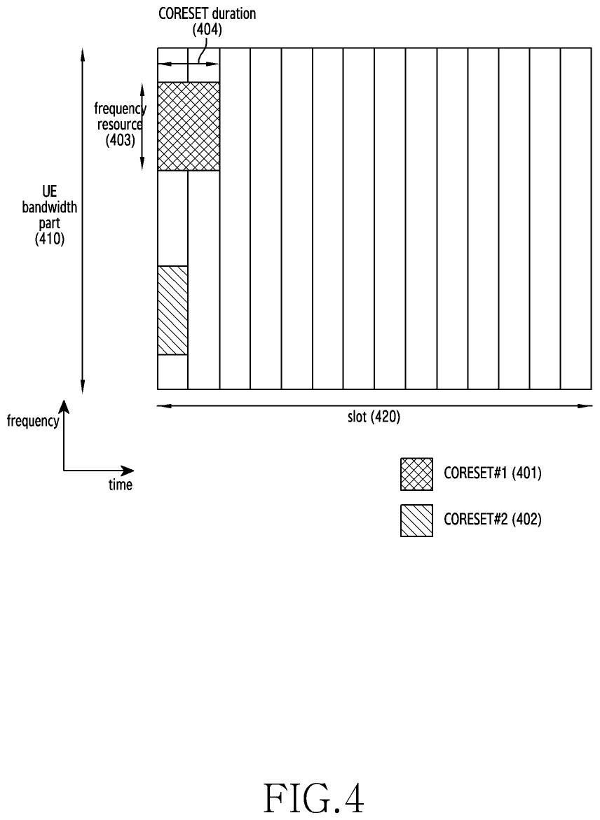

FIG. 4 illustrates an example of a control resource set (CORESET) used to transmit a downlink control channel in a 5G wireless communication system. FIG. 4 illustrates an example in which a UE bandwidth part 410 is configured along the frequency axis, and two control resource sets (control resource set #1 420 and control resource set #2 401) are configured within one slot 402 along the time axis. The control resource sets 401 and 402 may be configured in a specific frequency resource 410 within the entire UE bandwidth part 403 along the frequency axis. One or multiple OFDM symbols may be configured along the time axis, and this may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the control resource set may include the following pieces of information: given in Table 8 below.

TABLE 8

| | |
|---|---|
| ConControlResourceSet ::= | SEQUENCE { |

-- Corresponds to L1 parameter ‘CORESET-ID’

| | |
|---|---|
| controlResourceSetId | ControlResourceSetId, |
| (control resource set identity) | |
| frequency DomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-MappingType | CHOICE { |
| (CCE-to-REG mapping type) | |
| interleaved | SEQUENCE { |
| reg-BundleSize | ENUMERATED {n2, n3, n6}, |
| (REG bundle size) | |
| precoderGranularity | ENUMERATED { sameAsREG |
| -bundle, allContiguousRBs}, | |
| interleaverSize | ENUMERATED {n2, n3, n6} |
| (interleaver size) | |
| shiftIndex | INTEGER(0..maxNrofPhysical |
| ResourceBlocks-1) | OPTIONAL |
| (interleaver shift) | |
| }, | |
| nonInterleaved | NULL |
| }, | |
| tci-StatesPDCCH | SEQUENCE(SIZE (1..maxNrofTCI- |
| StatesPDCCH)) OF TCI-StateId | OPTIONAL, |
| (QCL configuration information) | |
| tci-PresentInDCI | ENUMERATED { enabled } |
| OPTIONAL, | ... Need S |
| } | |

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set. Obviously, the example given above is not limiting.

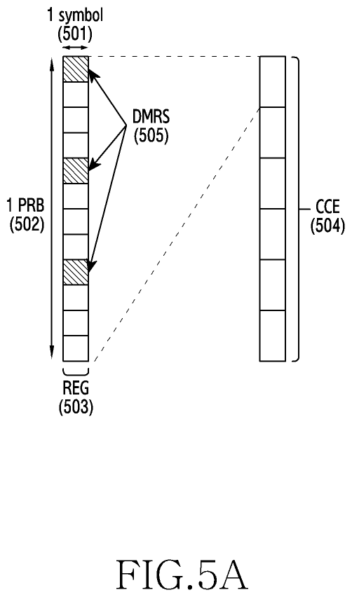

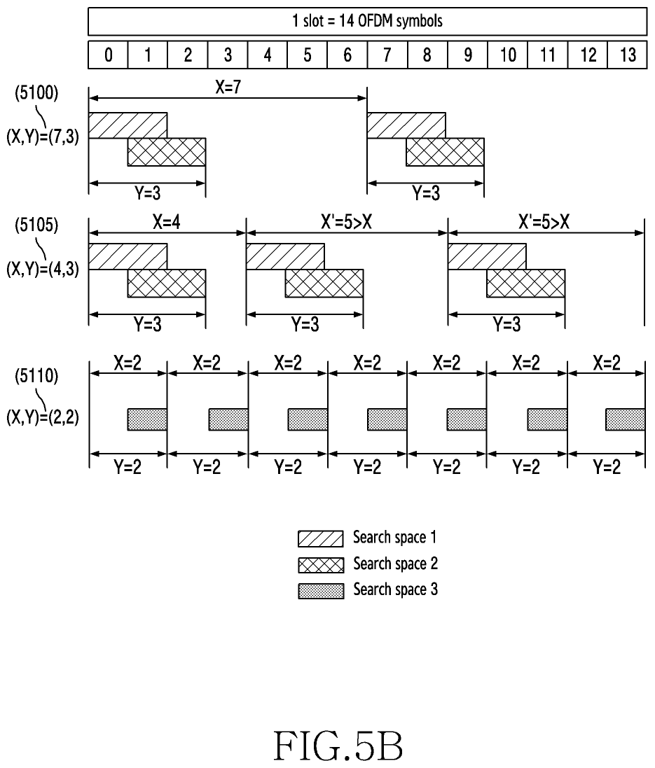

FIG. 5A illustrates an example of a basic unit of time and frequency resources constituting a downlink control channel available in a 5G system. According to FIG. 5, the basic unit of time and frequency resources constituting a control channel may be referred to as a resource element group (REG) 503, and the KEG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element (CCE) 504 as illustrated in FIG. 5A, one CCE 504 may include multiple REGs 503. To describe the REG 503 illustrated in FIG. 5A, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5A, that is, the REG 503, may include both REs to which DCI is mapped, and an area to which a reference signal (DMRS 505) for decoding the same is mapped. As in FIG. 5A, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the same may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the control resource set may include the following pieces of information: given in Table 9 below. Obviously, the example given below is not limiting.

TABLE 9

| | |
|---|---|
| SearchSpace ::= | SEQUENCE { |

-- Identity of the search space. SearchSpaceId = 0 identifies the SearchSpace configured
via PBCH (MIB) or ServingCellConfigCommon.

| | |
|---|---|
| search SpaceId | Search SpaceId, |
| (search space identity) | |
| controlResourceSetId | ControlResourceSetId, |
| (control resource set identity) | |
| monitoringSlotPeriodicityAndOffset | CHOICE { |
| (monitoring slot level periodicity) | |
| sl1 | NULL, |
| s12 | INTEGER (0..1), |
| s14 | INTEGER (0..3), |
| s15 | INTEGER (0..4), |
| s18 | INTEGER (0..7), |
| s110 | INTEGER (0..9), |
| s116 | INTEGER (0..15), |
| s120 | INTEGER (0..19) |
| } | |

OPTIONAL,

| | |
|---|---|
| duration (monitoring duration) | INTEGER (2..2559) |
| monitoringSymbolsWithinSlot | BIT STRING (SIZE (14)) |

OPTIONAL,

(monitoring symbols within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, |
| n8}, | |
| aggregationLevel2 | ENUMERATED {n0, n1, n2, n3, n4, n5, n6, |
| n8 }, | |
| aggregationLevel4 | ENUMERATED {n0, n1, n2, n3, n4, n5, n6, |
| n8}, | |
| aggregationLevel8 | ENUMERATED {n0, n1, n2, n3, n4, n5, n6, |
| n8}, | |
| aggregationLevel16 | ENUMERATED {n0, n1, n2, n3, n4, n5, n6, |
| n8} | |
| }, | |
| search SpaceType | CHOICE { |
| (search space type) | |

-- Configures this search space as common search space (CSS) and DCI formats to
monitor.

| | |
|---|---|
| common | SEQUENCE { |
| (common search space) | |
| } | |
| ue-Specific | SEQUENCE { |
| (UE-specific search space) | |

-- Indicates whether the UE monitors in this USS for DCI formats 0-0 and 1-0
or for formats 0-1 and 1-1.

| | |
|---|---|
| formats | ENUMERATED {formats0-0-And-1-0, |
| formats0-1-And-1-1}, | |
| ... | |
| } | |

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space sets. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting.

DCI format 0_0/1_0 with CRC scrambled by C-RNTI, CS-RNTI, SP-CSI-RNTI, RA-RNTI, TC-RNTI, P-RNTI, SI-RNTI

DCI format 2_0 with CRC scrambled by SFI-RNTI

DCI format 2_1 with CRC scrambled by INT-RNTI

DCI format 2_2 with CRC scrambled by TPC-PUSCH-RNTI, TPC-PUCCH-RNTI

DCI format 2_3 with CRC scrambled by TPC-SRS-RNTI

Combinations of DCI formats and RNTIs given below may be monitored in a UE-specific search space. Obviously, the example given below is not limiting.

DCI format 0_0/1_0 with CRC scrambled by C-RNTI, CS-RNTI, TC-RNTI

DCI format 1_0/1_1 with CRC scrambled by C-RNTI, CS-RNTI, TC-RNTI

Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

System information RNTI (SI-RNTI): used to schedule a PDSCH in which system information is transmitted

Interruption RNTI (INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI): used to indicate a power control command regarding a PUCCH

Transmit power control for SRS RNTI (TPC-SRS-RNTI): used to indicate a power control command regarding an SRS

The DCI formats enumerated above may follow the definitions given below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In a 5G system, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 2$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L

$$i = 0 , … , L - 1$$

$${Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 , {A}_{p} = 39827 for p mod 3 = 0 , {A}_{p} = 39829 for p mod 3 = 1 , {A}_{p} = 39839 for p mod 3 = 2 , D = 65537$$

n_{RNTI}: UE identity

The Y_{p,n}_{_{s,f}}_{^{μ}} value may correspond to 0 in the case of a common search space. The Y_{p,n}_{_{s,f}}_{^{μ}} value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [Pdcch: Span]

The UE may perform UE capability reporting at each subcarrier spacing with regard to a case in which the same has multiple PDCCH monitoring occasions inside a slot, and the concept “span” may be used in this regard. A span refers to consecutive symbols configured such that the UE can monitor the PDCCH inside the slot, and each PDCCH monitoring occasion is inside one span. A span may be described by (X, Y) wherein X refers to the minimum number of symbols by which the first symbols of two consecutive spans are spaced apart from each other, and Y refers to the number of consecutive symbols configured such that the PDCCH can be monitored inside one span. Here, a UE may monitor a PDCCH in a range of Y symbols from the first symbol of the span within the span.

FIG. 5B illustrates, in terms of spans, a case in which a UE may have multiple PDCCH monitoring occasions inside a slot in a wireless communication system. Possible spans are (X, Y)=(7,3), (4,3), (2,2), and the three cases may be indicated by (5100), (5105, and (5110) in FIG. 5B, respectively. According to an embodiment, (5100) may describe a case in which there are two spans described by (7,4) inside a slot. The spacing between the first symbols of two spans is described as X=7, a PDCCH monitoring occasion may exist inside a total of Y=3 symbols from the first symbol of each span, and search spaces 1 and 2 may exist inside Y=3 symbols, respectively. According to another embodiment, (5105) may describe a case in which there are a total of three spans described by (4,3) inside a slot, and the second and third spans are spaced apart by X′=5 symbols which are larger than X=4.

### [PDCCH: UE Capability Report]

The slot location at which the above-described common search space and the UE-specific search space are positioned is indicated by parameter “monitoringSymbolsWitninSlot” in Table 11-1, and the symbol location inside the slot is indicated as a bitmap through parameter “monitoringSymbolsWithinSlot” in Table 9. Meanwhile, the symbol location inside a slot at which the UE can monitor search spaces may be reported to the base station through the following UE capabilities.

UE capability 1 (hereinafter interchangeably used with FG 3-1) has the following meaning: if there is one monitoring occasion (MO) regarding type 1 and type 3 common search spaces or UE-specific search spaces inside a slot, as in the following Table 11-1, the UE can monitor the corresponding MO when the corresponding MO is located inside the first three symbols inside the slot. UE capability 1 is a mandatory capability which is to be supported by all UEs that support NR, and whether or not UE capability 1 is supported may not be explicitly reported to the base station. Obviously, the example given above is not limiting.

TABLE 11-1

| | Feature | | Field name in |
|---|---|---|---|
| Index | group | Components | TS 38.331 [2] |
| 3-1 | Basic DL | 1) One configured CORESET per BWP per cell in | n/a |
| | control | addition to CORESET0 | |
| | channel | CORESET resource allocation of 6RB bit-map | |
| | | and duration of 1-3 OFDM symbols for FR1 | |
| | | For type 1 CSS without dedicated RRC | |
| | | configuration and for type 0, 0A, and 2 CSSs, | |
| | | CORESET resource allocation of 6RB bit-map and | |
| | | duration 1-3 OFDM symbols for FR2 | |
| | | For type 1 CSS with dedicated RRC configuration | |
| | | and for type 3 CSS, UE specific SS, CORESET | |
| | | resource allocation of 6RB bit-map and duration | |
| | | 1-2 OFDM symbols for FR2 | |
| | | REG-bundle sizes of 2/3 RBs or 6 RBs | |
| | | Interleaved and non-interleaved CCE-to-REG | |
| | | mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast | |
| | | PDCCH transmission per BWP per cell | |
| | | PDCCH aggregation levels 1, 2, 4, 8, 16 | |
| | | UP to 3 search space sets in a slot for a scheduled | |
| | | SCell per BWP | |
| | | This search space limit is before applying all | |
| | | dropping rules. | |
| | | For type 1 CSS with dedicated RRC | |
| | | configuration, type 3 CSS, and UE-SS, the | |
| | | monitoring occasion is within the first 3 OFDM | |
| | | symbols of a slot | |
| | | For type 1 CSS without dedicated RRC | |
| | | configuration and for type 0, 0A, and 2 CSS, the | |
| | | monitoring occasion can be any OFDM symbol(s) | |
| | | of a slot, with the monitoring occasions for any of | |
| | | Type 1- CSS without dedicated RRC configuration, | |
| | | or Types 0, 0A, or 2 CSS configurations within a | |
| | | single span of three consecutive OFDM symbols | |
| | | within a slot | |
| | | 3) Monitoring DCI formats 0_0, 1_0, 0_1, 1_1 | |
| | | 4) Number of PDCCH blind decodes per slot with | |
| | | a given SCS follows Case 1-1 table | |
| | | 5) Processing one unicast DCI scheduling DL and | |
| | | one unicast DCI scheduling UL per slot per | |
| | | scheduled CC for FDD | |
| | | 6) Processing one unicast DCI scheduling DL and | |
| | | 2 unicast DCI scheduling UL per slot per | |
| | | scheduled CC for TDD | |

UE capability 2 (hereinafter interchangeably used with FG 3-2) has the following meaning: if there is one monitoring occasion (MO) regarding a common search space or a UE-specific search space inside a slot, as in the following Table 11-2, the UE can monitor the corresponding MO no matter what of the start symbol location of the corresponding MO may be. UE capability 2 is optionally supported by the UE, and whether or not UE capability 2 is supported may be explicitly reported to the base station. Obviously, the example given below is not limiting.

TABLE 11-2

| Index | Feature group | Components | Field name in TS 38.331 [2] |
|---|---|---|---|
| 3-2 | PDCCH | For a given UE, all search space | pdcchMonitoringSingleOccasion |
| | monitoring | configurations are within the same | |
| | on any | span of 3 consecutive OFDM | |
| | span of up | symbols in the slot | |
| | to 3 | | |
| | consecutive | | |
| | OFDM | | |
| | symbols | | |
| | of a slot | | |

UE capability 3 (hereinafter interchangeably used with FG 3-5, 3-5a, or 3-5b) has the following meaning: if there are multiple monitoring occasions (MO) regarding a common search space or a UE-specific search space inside a slot, as in the following Table 11-3, the pattern of the MO which the UE can monitor is indicated. The above-mentioned pattern includes the spacing X between start symbols of different MOs, and the maximum symbol length Y regarding one MO. The combination of (X, Y) supported by the UE may be one or multiple among {(2,2), (4,3), (7,3)}. UE capability 3 is optionally supported by the UE, and whether or not UE capability 3 is supported and the above-mentioned combination of (X, Y) may be explicitly reported to the base station. Obviously, the example given below is not limiting.

TABLE 11-3

| Index | Feature group | Components | Field name in TS 38.331 [2] |
|---|---|---|---|
| 3-5 | For type 1 | For type 1 CSS with dedicated RRC | pdcch- |
| | CSS with | configuration, type 3 CSS, and UE- | MonitoringAnyOccasions |
| | dedicated | SS, monitoring occasion can be any | {3-5. withoutDCI-Gap |
| | RRC | OFDM symbol(s) of a slot for Case 2 | 3-5a. withDCI-Gap} |
| | configuration, | | |
| | type 3 CSS, | | |
| | and UE-SS, | | |
| | monitoring | | |
| | occasion can | | |
| | be any | | |
| | OFDM | | |
| | symbol(s) of | | |
| | a slot for | | |
| | Case 2 | | |
| 3-5a | For type 1 | For type 1 CSS with dedicated RRC | |
| | CSS with | configuration, type 3 CSS and UE-SS, | |
| | dedicated | monitoring occasion can be any | |
| | RRC | OFDM symbol(s) of a slot for Case 2, | |
| | configuration, | with minimum time separation | |
| | type 3 CSS, | (including the cross-slot boundary | |
| | and UE-SS, | case) between two DL unicast DCIs, | |
| | monitoring | between two UL unicast DCIs, or | |
| | occasion can | between a DL and an UL unicast DCI | |
| | be any | in different monitoring occasions | |
| | OFDM | where at least one of them is not the | |
| | symbol(s) of | monitoring occasions of FG-3-1, for a | |
| | a slot for | same UE as | |
| | Case 2 with a | 2OFDM symbols for 15 kHz | |
| | DCI gap | 4OFDM symbols for 30 kHz | |
| | | 7OFDM symbols for 60 kHz | |
| | | with NCP | |
| | | 11OFDM symbols for 120 kHz | |
| | | Up to one unicast DL DCI and up to | |
| | | one unicast UL DCI in a monitoring | |
| | | occasion except for the monitoring | |
| | | occasions of FG 3-1. | |
| | | In addition for TDD the minimum | |
| | | separation between the first two UL | |
| | | unicast DCIs within the first 3 OFDM | |
| | | symbols of a slot can be zero OFDM | |
| | | symbols. | |
| 3-5b | All PDCCH | PDCCH monitoring occasions of FG- | |
| | monitoring | 3-1, plus additional PDCCH | |
| | occasion can | monitoring occasion(s) can be any | |
| | be any | OFDM symbol(s) of a slot for Case 2, | |
| | OFDM | and for any two PDCCH monitoring | |
| | symbol(s) of | occasions belonging to different spans, | |
| | a slot for | where at least one of them is not the | |
| | Case 2 with a | monitoring occasions of FG-3-1, in | |
| | span gap | same or different search spaces, there | |
| | | is a minimum time separation of X | |
| | | OFDM symbols (including the cross- | |
| | | slot boundary case) between the start | |
| | | of two spans, where each span is of | |
| | | length up to Y consecutive OFDM | |
| | | symbols of a slot. Spans do not | |
| | | overlap. Every span is contained in a | |
| | | single slot. The same span pattern | |
| | | repeats in every slot. The separation | |
| | | between consecutive spans within and | |
| | | across slots may be unequal but the | |
| | | same (X, Y) limit must be satisfied by | |
| | | all spans. Every monitoring occasion | |
| | | is fully contained in one span. In order | |
| | | to determine a suitable span pattern, | |
| | | first a bitmap b(l), 0 <= l <= 13 is | |
| | | generated, where b(l) = 1 if symbol l of | |
| | | any slot is part of a monitoring | |
| | | occasion, b(l) = 0 otherwise. The first | |
| | | span in the span pattern begins at the | |
| | | smallest l for which b(l) = 1. The next | |
| | | span in the span pattern begins at the | |
| | | smallest l not included in the previous | |
| | | span(s) for which b(l) = 1. The span | |
| | | duration is max {maximum value of all | |
| | | CORESET durations, minimum value | |
| | | of Y in the UE reported candidate | |
| | | value} except possibly the last span in | |
| | | a slot which can be of shorter duration. | |
| | | A particular PDCCH monitoring | |
| | | configuration meets the UE capability | |
| | | limitation if the span arrangement | |
| | | satisfies the gap separation for at least | |
| | | one (X, Y) in the UE reported | |
| | | candidate value set in every slot, | |
| | | including cross slot boundary. | |
| | | For the set of monitoring occasions | |
| | | which are within the same span: | |
| | | Processing one unicast DCI | |
| | | scheduling DL and one unicast DCI | |
| | | scheduling UL per scheduled CC | |
| | | across this set of monitoring occasions | |
| | | for FDD | |
| | | Processing one unicast DCI | |
| | | scheduling DL and two unicast DCI | |
| | | scheduling UL per scheduled CC | |
| | | across this set of monitoring occasions | |
| | | for TDD | |
| | | Processing two unicast DCI | |
| | | scheduling DL and one unicast DCI | |
| | | scheduling UL per scheduled CC | |
| | | across this set of monitoring occasions | |
| | | for TDD | |
| | | The number of different start symbol | |
| | | indices of spans for all PDCCH | |
| | | monitoring occasions per slot, | |
| | | including PDCCH monitoring | |
| | | occasions of FG-3-1, is no more than | |
| | | floor(14/X) (X is minimum among | |
| | | values reported by UE). | |
| | | The number of different start symbol | |
| | | indices of PDCCH monitoring | |
| | | occasions per slot including PDCCH | |
| | | monitoring occasions of FG-3-1, is no | |
| | | more than 7. | |
| | | The number of different start symbol | |
| | | indices of PDCCH monitoring | |
| | | occasions per half-slot including | |
| | | PDCCH monitoring occasions of FG- | |
| | | 3-1 is no more than 4 in SCell. | |

The UE may report whether the above-described capability 2 and/or capability 3 are supported and relevant parameters to the base station. The base station may allocate time-domain resources to the common search space and the UE-specific search space, based on the UE capability report. During the resource allocation, the base station may ensure that the MO is not positioned not at a location at which the UE cannot monitor the same.

### [Pdcch: Bd/Cce Limit]

If there are multiple search space sets configured for a UE, the following conditions may be considered in connection with a method for determining a search space set to be monitored by the UE.

If the value of “monitoringCapabilityConfig-r16” (upper layer signaling) has been configured to be “r15monitoringcapability” for the UE, the UE defines maximum values regarding the number of PDCCH candidates that can be monitored and the number of CCEs constituting the entire search space (as used herein, the entire search space refers to the entire CCE set corresponding to a union domain of multiple search space sets) with regard to each slot. If the value of “monitoringCapabilityConfig-r16” has been configured to be “r16monitoringcapability”, the UE defines maximum values regarding the number of PDCCH candidates that can be monitored and the number of CCEs constituting the entire search space (as used herein, the entire search space refers to the entire CCE set corresponding to a union domain of multiple search space sets) with regard to each span.

### [Condition 1: Maximum Number of PDCCH Candidates Limited]

According to the upper layer signaling configuration value, the maximum number M^{μ} of PDCCH candidates that the UE can monitor may follow Table 12-1 given below if the same is defined with reference to a slot in a cell configured to have a subcarrier spacing of 15·2^{μ} kHz, and may follow Table 12-2 given below if the same is defined with reference to a span.

TABLE 12-1

| | Maximum number of PDCCH candidates |
|---|---|
| μ | per slot and per serving cell (M^{μ}) |
| 0 | 44 |
| 1 | 36 |
| 2 | 22 |
| 3 | 20 |

TABLE 12-2

| | Maximum number M^{μ} of monitored PDCCH | | |
|---|---|---|---|
| | candidates per span for combination (X, Y) and | | |
| | per serving cell | | |
| μ | (2, 2) | (4, 3) | (7, 3) |
| 0 | 14 | 28 | 44 |
| 1 | 12 | 24 | 36 |

### [Condition 2: Maximum Number of CCEs Limited]

According to the upper layer signaling configuration value, the maximum number C^{μ} of CCEs constituting the entire search space (as used herein, the entire search space refers to the entire CCE set corresponding to a union domain of multiple search space sets) may follow Table 12-3 given below if the same is defined with reference to a slot in a cell configured to have a subcarrier spacing of 15·2^{μ} kHz, and may follow Table 12-4 given below if the same is defined with reference to a span.

TABLE 12-3

| | Maximum number of non-overlapped CCEs |
|---|---|
| μ | per slot and per serving cell (C^{μ}) |
| 0 | 56 |
| 1 | 56 |
| 2 | 48 |
| 3 | 32 |

TABLE 12-4

| | Maximum number C^{μ} of non-overlapped CCEs per | | |
|---|---|---|---|
| | span for combination (X, Y) and per serving cell | | |
| μ | (2, 2) | (4, 3) | (7, 3) |
| 0 | 18 | 36 | 56 |
| 1 | 18 | 36 | 56 |

For the sake of descriptive convenience, a situation satisfying both conditions 1 and 2 above at a specific timepoint may be defined as “condition A”. Therefore, the description that condition A is not satisfied may mean that at least one of conditions 1 and 2 above is not satisfied.

### [Pdcch: Overbooking]

According to the configuration of search space sets of the base station, a case in which condition A is not satisfied may occur at a specific timepoint. If condition A is not satisfied at a specific timepoint, the UE may select and monitor only some of search space sets configured to satisfy condition A at the corresponding timepoint, and the base station may transmit a PDCCH to the selected search space set.

A method for selecting some search spaces from all configured search space sets may follow methods given below.

If condition A regarding a PDCCH fails to be satisfied at a specific timepoint (slot), the UE (or the base station) may preferentially select a search space set having a search space type configured as a common search space, among search space sets existing at the corresponding timepoint, over a search space set configured as a UE-specific search space.

If all search space sets configured as common search spaces have been selected (that is, if condition A is satisfied even after all search spaces configured as common search spaces have been selected), the UE (or the bae station) may select search space sets configured as UE-specific search spaces. If there are multiple search space sets configured as UE-specific search spaces, a search space set having a lower search space set index may have a higher priority. UE-specific search space sets may be selected as long as condition A is satisfied, in consideration of the priority.

### [QCL, TCI State]

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a quasi-co-location (QCL) configuration as in Table 10 below. A TCI state is for announcing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 10 below.

TABLE 13

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE though RRC parameter TCI-state and QCL-info as in Table 14 below. Referring to Table 14, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) that each TCI state may include the serving cell index and the BWP index of the reference RS indicated by the corresponding QCL information, the type and ID of the reference BS, and a QCL type as in Table 13 above. Obviously, the example given above is not limiting.

TABLE 14

| | |
|---|---|
| TCI-State ::= | SEQUENCE |

| | |
|---|---|
| tci-StateId | TCI-StateId, |
| (ID of corresponding TCI state) | |
| qcl-Type1 | QCL-Info, |

(QCL information of first refernece RS of RS (target RS) referring to

| | |
|---|---|
| corresponding TCI state ID) | |
| qcl-Type2 | QCL-Info OPTIONAL, - |
| - Need R | |

```
    (QCL information of second refernece RS of RS (target RS) referring to
corresponding TCI state ID)
    ...
```

| | |
|---|---|
| QCL-Info ::= | SEQUENCE { |
| cell | ServCellIndex OPTIONAL, -- |

Need R

(serving cell index of reference RS indicated by corresponding QCL information)

| | |
|---|---|
| bwp-Id | BWP-Id |
| OPTIONAL, -- Cond CSI-RS-Indicated | |

(BWP index of reference RS indicated by corresponding QCL information)

| | |
|---|---|
| referenceSignal | CHOICE { |
| csi-rs | NZP-CSI-RS-ResourceId, |
| ssb | SSB-Index |

(one of CSI-RS ID or SSB ID indicated by corresponding QCL information)

| | |
|---|---|
| }, | |
| qcl-Type | ENUMERATED typeA, typeB, typeC, |
| typeD}, | |
| ... | |
| } | |

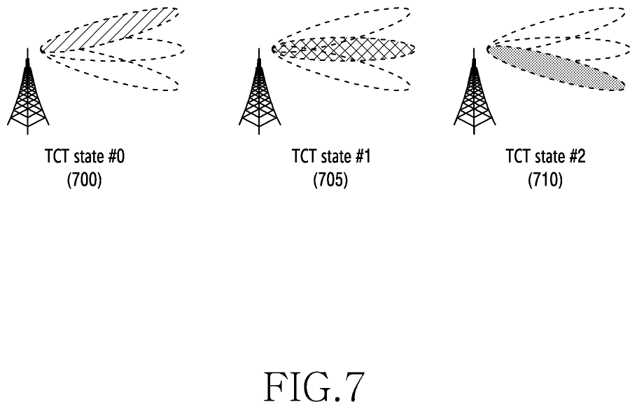

FIG. 7 illustrates an example of base station beam allocation according to TCI state configuration. Referring to FIG. 7, the base station may transfer information regarding N different beams to the UE through N different TCI states. For example, in the case of N=3 as in FIG. 7, the base station may configure qcl-Type2 parameters included in three TCI states 700, 705, and 710 in QCL type D while being associated with CSI-RSs or SSBs corresponding to different beams, thereby notifying that antenna ports referring to the different TCI states 700, 705, and 710 are associated with different spatial Rx parameters (that is, different beams).

Tables 15-1 to 15-5 below enumerate valid TCI state configurations according to the target antenna port type.

Table 15-1 enumerates valid TCI state configurations when the target antenna port is a CSI-RS for tracking (TRS) The TRS refers to an NZP CSI-RS which has no repetition parameter configured therefor, and trs-Info of which is configured as “true”, among CRI-RSs. In Table 15-1, configuration no. 3 may be used for an aperiodic TRS. Obviously, the example given below is not limiting.

TABLE 15-1
Valid TCI state configurations when the target
antenna port is a CSI-RS for tracking (TRS)

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 15-2 enumerates valid TCI state configurations when the target antenna port is a CSI-RS for CSI. The CSI-RS for CSI may refer to an NZP CSI-RS which has no parameter indicating repetition (for example, repetition parameter) configured therefor, and trs-Info of which is not configured as “true”, among CRI-RSs. Obviously, the example given above is not limiting.

TABLE 15-2
Valid TCI state configurations when the
target antenna port is a CSI-RS for CSI

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 15-3 enumerates valid TCI state configurations when the target antenna port is a CSI-RS for beam management (BM) (which has the same meaning as CSI-RS for L1 RSRP reporting). The CSI-RS for BM refers to an NZP CSI-RS which has a repetition parameter configured to have a value of “on” or “off”, and trs-Info of which is not configured as “true”, among CRI-RSs. Obviously, the example given below is not limiting.

TABLE 15-3
Valid TCI state configurations when the target antenna
port is a CSI-RS for BM (for L1 RSRP reporting)

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 15-4 enumerates valid TCI state configurations when the target antenna port is a PDCCH DMRS. Obviously, the example given below is not limiting.

TABLE 15-4
Valid TCI state configurations when the
target antenna port is a PDCCH DMRS

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS (same | QCL-TypeD |
| | | | as DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 15-5 enumerates valid TCI state configurations when the target antenna port is a PDSCH DMRS. Obviously, the example given below is not limiting.

TABLE 15-5
Valid TCI state configurations when the
target antenna port is a PDSCH DMRS

| Valid TCI | | | DL RS 2 | qcl-Type2 |
|---|---|---|---|---|
| state | | | (If | (If |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS | QCL-TypeD |
| | (CSI) | | (CSI) | |

According to a representative QCL configuration method based on Tables 15-1 to 15-5 above, the target antenna port and reference antenna port for each step are configured and operated such as “SSB”->“TRS”->“CSI-RS for CSI, or CSI-RS for BM, or PDCCH DMRS, or PDSCH DMRS”. Accordingly, it may be possible to help the UE's receiving operation by associating statistical characteristics that can be measured from the SSB and TRS with respective antenna ports.

### [PDCCH: Regarding TCI State]

Specific TCI state combinations applicable to a PDCCH DMRS antenna port may be given in Table 16 below. The fourth row in Table 16 corresponds to a combination assumed by the UE before RRC configuration, and no configuration is possible after the RRC.

TABLE 16

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | | |
| | (CSI) | | | |
| 4 | SS/PBCH | QCL-TypeA | SS/PBCH | QCL-TypeD |
| | Block | | Block | |

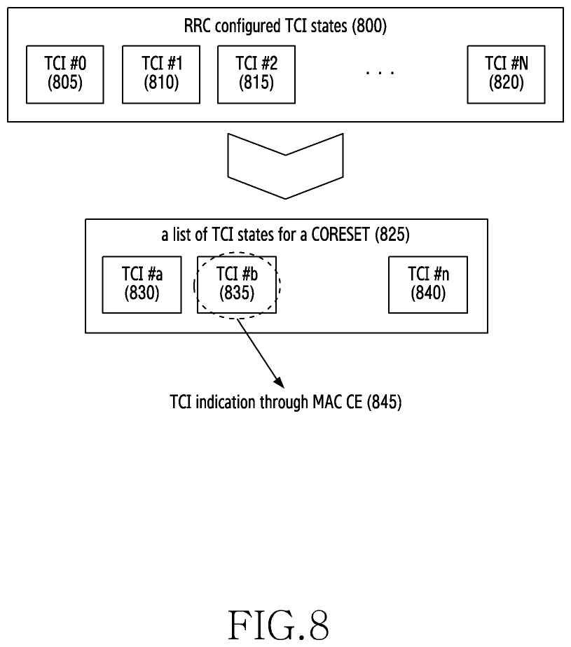

In NR, a hierarchical signaling method as illustrated in FIG. 8 is supported for dynamic allocation regarding a PDCCH beam. Referring to FIG. 8, the base station may configure N TCI states 805, 810, . . . , 820 for the UE through RRC signaling 800, and may configure some of the states as TCI states for a CORESET (825). The base station may then indicate one of the TCI states 830, 835, and 840 for the CORESET to the UE through MAC CE signaling (845). The UE may then receive a PDCCH, based on beam information included in the TCI state indicated by the MAC CE signaling.

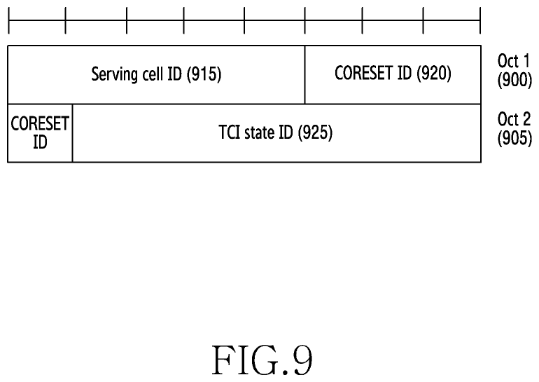

FIG. 9 illustrates a TCI indication MAC CE signaling structure for the PDCCH DMRS. Referring to FIG. 9, the TCI indication MAC CE signaling for the PDCCH DMRS may be configured by 2 bytes (16 bits), and include a 5-bit serving cell ID 915, a 4-bit CORESET ID 920, and a 7-bit TCI state ID 925.

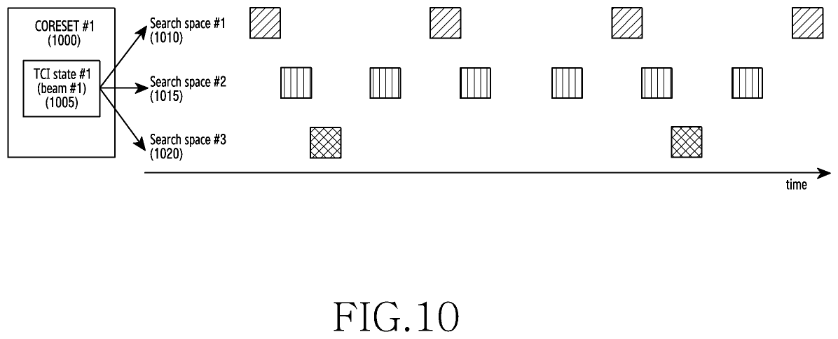

FIG. 10 illustrates an example of beam configuration with regard to a control resource set (CORESET) and a search space according to the above description. Referring to FIG. 10, the base station may indicate one of TCI state lists included in CORESET 1000 configuration through MAC CE signaling (1005). Until a different TCI state is indicated for the corresponding CORESET through different MAC CE signaling, the UE may consider that identical QCL information (beam #1) 1005 is all applied to one or more search spaces 1010, 1015, and 1020 connected to the CORESET. The above-described PDCCH beam allocation method may have a problem in that it is difficult to indicate a beam change faster than MAC CE signaling delay, and the same beam is unilaterally applied to each CORESET regardless of search space characteristics, thereby making flexible PDCCH beam operation difficult. In the following embodiments of the disclosure, more flexible PDCCH beam configuration and operation methods will be provided. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set, and may activate one of the configured TCI states through a MAC CE activation command. For example, if {TCI state #0, TCI state #1, TCI state #2} are configured as TCI states for control resource set #1, the base station may transmit an activation command to the UE through a MAC CE such that TCI state #0 is assumed as the TCI state regarding control resource set #1. Based on the activation command regarding the TCI state received through the MAC CE, the UE may correctly receive the DMRS of the corresponding CORESET, based on QCL information in the activated TCI state.

With regard to a CORESET having a configured index of 0 (CORESET #0), if the UE has failed to receive a MAC CE activation command regarding the TCI state of CORESET #0, the UE may assume that the DMRS transmitted in CORESET #0 has been QCL-ed with a SS/PBCH block identified in the initial access process, or in a non-contention-based random access process not triggered by a PDCCH command.

With regard to a CORESET having a configured index value other than 0 (CORESET #X), if the UE has no TCI state configured regarding CORESET #X, or if the UE has one or more TCI states configured therefor but has failed to receive a MAC CE activation command for activating one thereof, the UE may assume that the DMRS transmitted in CORESET #X has been QCL-ed with a SS/PBCH block identified in the initial access process.

### [PDCCH: Regarding QCL Prioritization Rule]

Hereinafter, operations for determining QCL priority regarding a PDCCH will be described in detail.

If multiple control resource sets which operate according to carrier aggregation inside a single cell or band and which exist inside a single or multiple in-cell activated bandwidth parts overlap temporally while having identical or different QCL-TypeD characteristics in a specific PDCCH monitoring occasion, the UE may select a specific control resource set according to a QCL priority determining operation and may monitor control resource sets having the same QCL-TypeD characteristics as the corresponding control resource set. That is, if multiple control resource sets overlap temporally, only one QCL-TypeD characteristic can be received. The QCL priority may be determined by the following criteria.

Criterion 1: A control resource set connected to a common search space having the lowest index inside a cell corresponding to the lowest index among cells including a common search space

Criterion 2: A control resource set connected to a UE-specific search space having the lowest index inside a cell corresponding to the lowest index among cells including a UE-specific search space

As described above, if one criterion among the criteria is not satisfied, the next criterion may be applied. For example, if control resource sets overlap temporally in a specific PDCCH monitoring occasion, and if all control resource sets are not connected to a common search space but connected to a UE-specific search space (for example, if criterion 1 is not satisfied), the UE may omit application of criterion 1 and apply criterion 2. Obviously, the example given above is not limiting.

If selecting control resource set according to the above-mentioned criteria, the UE may additionally consider the two aspects with regard to QCL information configured for the control resource set. Firstly, if control resource set 1 has CSI-RS 1 as a reference signal having a relation of QCL-TypeD, if this CSI-RS 1 has a relation of QCL-TypeD with reference signal SSB 1, and if another control resource set 2 has a relation of QCL-TypeD with reference signal SSB 1, the UE may consider that the two control resource sets 1 and 2 have different QCL-TypeD characteristics. Secondly, if control resource set 1 has CSI-RS 1 configured for cell 1 as a reference signal having a relation of QCL-TypeD, if this CSI-RS 1 has a relation of QCL-TypeD with reference signal SSB 1, if control resource set 2 has a relation of QCL-TypeD with reference signal CSI-RS 2 configured for cell 2, and if this CSI-RS 2 has a relation of QCL-TypeD with the same reference signal SSB 1, the UE may consider that the two control resource sets have the same QCL-TypeD characteristics.

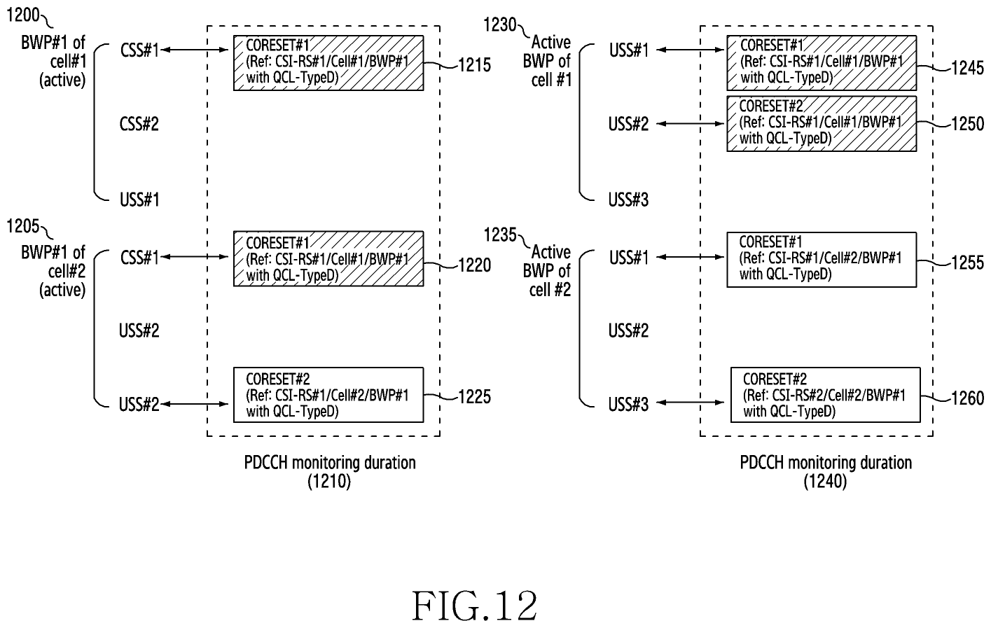

FIG. 12 illustrates a method in which, upon receiving a downlink control channel, a UE selects a receivable control resource set in consideration of priority in a wireless communication system according to an embodiment of the disclosure. As an example, the UE may be configured to receive multiple control resource sets overlapping temporally in a specific PDCCH monitoring occasion 1210, and such multiple control resource sets may be connected to a common search space or a UE-specific search space with regard to multiple cells. In the corresponding PDCCH monitoring occasion, control resource set no. 1 1200 connected to common search space no. 1 may exist in bandwidth part no. 1 1215 of cell no. 1, and control resource set no. 1 1205 connected to common search space no. 1 and control resource set no. 2 1220 connected to UE-specific search space no. 2 may exist in bandwidth part no. 1 1225 of cell no. 2. The control resource sets 1215 and 1220 may have a relation of QCL-TypeD with CSI-RS resource no. 1 configured in bandwidth part no. 1 of cell no. 1, and the control resource set 1225 may have a relation of QCL-TypeD with CSI-RS resource no. 1 configured in bandwidth part no. 1 of cell no. 2. If criterion 1 is applied to the corresponding PDCCH monitoring occasion 1210, all other control resource sets having the same reference signal of QCL-TypeD as control resource set no. 1 1215 may be received. Therefore, the UE may receive the control resource sets 1210 and 1215 in the corresponding PDCCH monitoring occasion 1220.

As another example, the UE may be configured to receive multiple control resource sets overlapping temporally in a specific PDCCH monitoring occasion 1240, and such multiple control resource sets may be connected to a common search space or a UE-specific search space with regard to multiple cells. In the corresponding PDCCH monitoring occasion, control resource set no. 1 1230 connected to UE-specific search space no. 1 and control resource set no. 2 1245 connected to UE-specific search space no. 2 may exist in bandwidth part no. 1 1250 of cell no. 1, and control resource set no. 1 1235 connected to UE-specific search space no. 1 and control resource set no. 2 1255 connected to UE-specific search space no. 3 may exist in bandwidth part no. 1 1260 of cell no. 2. The control resource sets 1245 and 1250 may have a relation of QCL-TypeD with CSI-RS resource no. 1 configured in bandwidth part no. 1 of cell no. 1, the control resource set 1255 may have a relation of QCL-TypeD with CSI-RS resource no. 1 configured in bandwidth part no. 1 of cell no. 2, and the control resource set 1260 may have a relation of QCL-TypeD with CSI-RS resource no. 2 configured in bandwidth part no. 1 of cell no. 2. If criterion 1 is applied to the corresponding PDCCH monitoring occasion 1240, there is no common search space, and the next criterion, that is, criterion 2, may thus be applied. If criterion 2 is applied to the corresponding PDCCH monitoring occasion 1240, all other control resource sets having the same reference signal of QCL-TypeD as control resource set no. 1 1245 may be received. Therefore, the UE may receive the control resource sets 1240 and 1245 in the corresponding PDCCH monitoring occasion 1250.

### [Regarding Rate Matching/Puncturing]

Hereinafter, a rate matching operation and a puncturing operation will be described in detail.

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

### Rate Matching Operation

The base station may transmit channel A after mapping the same only to remaining resource domains other than resource C (area overlapping resource B) among the entire resource A which is to be used to transmit symbol sequence A to the UE. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3}(corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A based on an assumption that symbol sequence A has been mapped and transmitted in the remaining area other than resource C among the entire resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3}(corresponding to resource C) among resource A. Consequently, the UE may perform a series of following receiving operations based on an assumption that symbol sequence {symbol #1, symbol #2, symbol #4} has been transmitted after being mapped to {resource #1, resource #2, resource #4}, respectively. Of course, the examples given above are not limiting.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, if symbol sequence A is configured as {symbol #1, symbol #2, symbol #3, symbol4}, resource A is {resource #1, resource #2, resource #3, resource #4}, and resource B is {resource #3, resource #5}, the base station may map symbol sequence {symbol #1, symbol #2, symbol #3, symbol #4} to resource A {resource #1, resource #2, resource #3, resource #4}, respectively, may transmit only symbol sequence {symbol #1, symbol #2, symbol #4} corresponding to remaining resources {resource #1, resource #2, resource #4} other than {resource #3}(corresponding to resource C) among resource A, and may not transmit {symbol #3} mapped to {resource #3}(corresponding to resource C). Consequently, the base station may transmit symbol sequence {symbol #1, symbol #2, symbol #4} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped to the entire resource A but transmitted only in the remaining area other than resource C among the resource area A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3}(corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Hereinafter, a method for configuring a rate matching resource for the purpose of rate matching in a 5G communication system will be described. Rate matching refers to adjusting the size of a signal in consideration of the amount of resources that can be used to transmit the signal. For example, data channel rate matching may mean that a data channel is not mapped and transmitted with regard to specific time and frequency resource domains, and the size of data is adjusted accordingly.

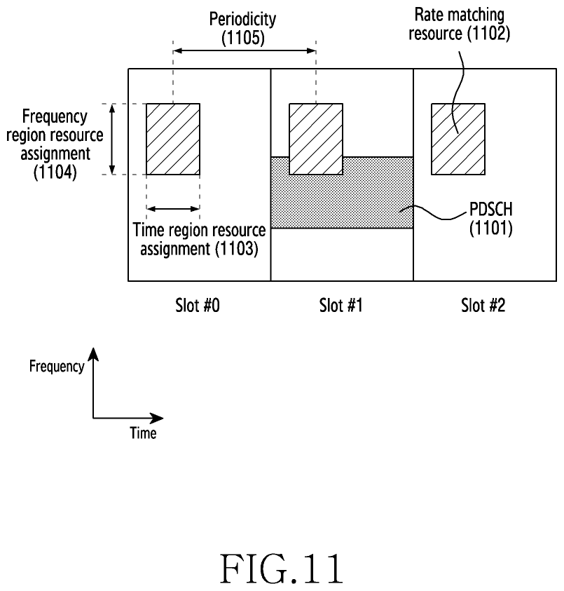

FIG. 11 illustrates a method in which a base station and a UE transmit/receive data in consideration of a downlink data channel and a rate matching resource.

FIG. 11 illustrates a downlink data channel (PDSCH) 1101 and a rate matching resource 1102. The base station may configure one or multiple rate matching resources 1102 for the UE through upper layer signaling (for example, RRC signaling). Rate matching resource 1102 configuration information may include time-domain resource allocation information 1103, frequency-domain resource allocation information 1104, and periodicity information 1105. A bitmap corresponding to the frequency-domain resource allocation information 1104 will hereinafter be referred to as “first bitmap”, a bitmap corresponding to the time-domain resource allocation information 1103 will be referred to as “second bitmap”, and a bitmap corresponding to the periodicity information 1105 will be referred to as “third bitmap”. If all or some of time and frequency resources of the scheduled PDSCH 1101 overlap a configured rate matching resource 1102, the base station may rate-match and transmit the PDSCH 1101 in a rate matching resource 1102 part, and the UE may perform reception and decoding after assuming that the PDSCH 1101 has been rate-matched in a rate matching resource 1102 part.

The base station may dynamically notify the UE, through DCI, of whether the PDSCH will be rate-matched in the configured rate matching resource part through an additional configuration (for example, corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described rate matching resources for a UE. More specifically, the following configuration method may be followed.

### RB Symbol Level

The UE may have a maximum of four RateMatchPatterns configured per each bandwidth part through upper layer signaling, and one RateMatchPattern may include the following contents. Obviously, the example given below is not limiting.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. A time domain pattern (periodicityAndPattern) may be additionally configured wherein time and frequency domains including respective RB-level and symbol-level bitmap pairs are repeated.
may include a resource area corresponding to a time domain pattern configured by time and frequency domain resource areas configured by a CORESET inside a bandwidth part and a search space configuration in which corresponding resource areas are repeated.

### RE Level

The UE may have the following contents configured through upper layer signaling. Obviously, the example given below is not limiting.
configuration information (lte-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

### [Regarding LTE CRS Rate Match]

Next, a rate matching process regarding the above-mentioned LTE CRS will be described in detail. In NR, for coexistence between long term evolution (LTE) and new RAT (NR) (LTE-NR coexistence), the pattern of cell-specific reference signal (CRS) of LTE may be configured for an NR UE. More specifically, the CRS pattern may be provided by RRC signaling including at least one parameter inside ServingCellConfig IE (information element) or ServingCellConfigCommon IE. Examples of the parameter may include lte-CRS-ToMatchAround, lte-CRS-PatternList1-r16, lte-CRS-PatternList2-r16, crs-RateMatch-PerCORESETPoolIndex-r16, and the like.

Rel-15 NR may provide a function by which one CRS pattern can be configured per serving cell through parameter lte-CRS-ToMatchAround. In Rel-16 NR, the above function has been expanded such that multiple CRS patterns can be configured per serving cell. More specifically, a UE having a single-TRP (transmission and reception point) configuration may now have one CRS pattern configured per one LTE carrier, and a UE having a multi-TRP configuration may now have two CRS patterns configured per one LTE carrier. For example, the UE having a single-TRP configuration may have a maximum of three CRS patterns configured per serving cell through parameter lte-CRS-PatternList1-r16. As another example, the UE having a multi-TRP configuration may have a CRS configured for each TRP.

That is, the CRS pattern regarding TRP1 may be configured through parameter lte-CRS-PatternList1-r16, and the CRS pattern regarding TRP2 may be configured through parameter lte-CRS-PatternList2-r16. If two TRPs are configured as above, whether the CRS patterns of TRP1 and TRP2 are both to be applied to a specific physical downlink shared channel (PDSCH) or only the CRS pattern regarding one TRP is to be applied is determined through parameter crs-RateMatch-PerCORESETPoolIndex-r16, wherein if parameter crs-RateMatch-PerCORESETPoolIndex-r16 is configured “enabled”, only the CRS pattern of one TRP is applied, and both CRS patterns of the two TRPs are applied in other cases.

Table 17 shows a ServingCellConfig IE including the CRS patterns, and Table 18 shows a RateMatchPatternLTE-CRS IE including at least one parameter regarding CRS patterns.

TABLE 17
ServingCellConfig ::= SEQUENCE {

| | |
|---|---|
| tdd-UL-DL-ConfigurationDedicated | TDD-UL-DL-ConfigDedicated |
| OPTIONAL, -- Cond TDD | |
| initialDownlinkBWP | BWP-DownlinkDedicated |
| OPTIONAL, -- Need M | |

```
  downlinkBWP-ToReleaseList  SEQUENCE (SIZE (1..maxNrofBWPs)) OF BWP-
Id OPTIONAL,  -- Need N
  downlinkBWP-ToAddModList  SEQUENCE (SIZE (1..maxNrofBWPs)) OF BWP-
Downlink  OPTIONAL, -- Need N
```

| | |
|---|---|
| firstActiveDownlinkBWP-Id | BWP-Id |

OPTIONAL, -- Cond SyncAndCellAdd

| | |
|---|---|
| bwp-Inactivity Timer | ENUMERATED {ms2, ms3, ms4, ms5, ms6, ms8, |
| ms10, ms20, ms30, | |
| | ms40,ms50, ms60, ms80,ms100, |
| ms200,ms300, ms500, | |
| | ms750, ms1280, ms1920, ms2560, |
| spare10, spare9, spare8, | |
| | spare7, spare6, spare5, spare4, |
| spare3, spare2, spare1 } OPTIONAL, | -- Need R |
| defaultDownlinkBWP-Id | BWP-Id |
| OPTIONAL, -- Need S | UplinkConfig |
| uplinkConfig | |
| OPTIONAL, -- Need M | UplinkConfig |
| supplementary Uplink | |
| OPTIONAL, -- Need M | SetupRelease { PDCCH-ServingCellConfig } |
| pdcch-ServingCellConfig | |
| OPTIONAL, -- Need M | |
| pdsch-ServingCellConfig | SetupRelease { PDSCH-ServingCellConfig } |
| OPTIONAL, -- Need M | |
| csi-MeasConfig | SetupRelease { CSI-MeasConfig } |
| OPTIONAL, -- Need M | |
| sCellDeactivation Timer | ENUMERATED {ms20, ms40, ms80, ms160, |
| ms200, ms240, | |
| | ms320, ms400, ms480, ms520, ms640, |
| ms720, | |
| | ms840, ms1280, spare2, spare1 } |

OPTIONAL, -- Cond ServingCellWithoutPUCCH

| | |
|---|---|
| crossCarrierSchedulingConfig | CrossCarrierSchedulingConfig |
| OPTIONAL, -- Need M | |

| | |
|---|---|
| tag-Id | TAG-Id, |

| | |
|---|---|
| dummy | ENUMERATED { enabled} |
| OPTIONAL, -- Need R | |
| pathlossReferenceLinking | ENUMERATED {spCell, sCell} |
| OPTIONAL, -- Cond SCellOnly | |
| servingCellMO | MeasObjectId |
| OPTIONAL, -- Cond MeasObject | |
| ..., | |
| [[ | |
| lte-CRS-ToMatchAround | SetupRelease { RateMatchPatternLTE-CRS } |
| OPTIONAL, -- Need M | |
| rateMatchPatternToAddModList | SEQUENCE (SIZE |

(1..maxNrofRateMatchPatterns)) OF RateMatchPattern OPTIONAL, -- Need N

| | |
|---|---|
| rateMatchPattern ToReleaseList | SEQUENCE (SIZE |

(1..maxNrofRateMatchPatterns)) OF RateMatchPatternId OPTIONAL, -- Need N

| | |
|---|---|
| downlinkChannelBW-PerSCS-List | SEQUENCE (SIZE (1..maxSCSs)) OF SCS- |

SpecificCarrier OPTIONAL -- Need S

| | |
|---|---|
| ]], | |
| [[ | |
| supplementaryUplinkRelease | ENUMERATED {true} |
| OPTIONAL, -- Need N | |

TDD-UL-DL-ConfigDedicated-
tdd-UL-DL-ConfigurationDedicated-IAB-MT-r16 TDD-UL-DL-ConfigDedicated-
IAB-MT-r16 OPTIONAL, -- Cond TDD_IAB

| | |
|---|---|
| dormantBWP-Config-r16 | SetupRelease { DormantBWP-Config-r16 } |
| OPTIONAL, -- Need M | |

| | |
|---|---|
| ca-SlotOffset-r16 | CHOICE { |

| | |
|---|---|
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |
| } | OPTIONAL, |
| -- Cond AsyncCA | |
| channelAccessConfig-r16 | SetupRelease { ChannelAccessConfig-r16 } |
| OPTIONAL, -- Need M | |
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWith-DCI-r16 | ENUMERATED {enabled} |
| OPTIONAL, -- Need R | |
| lte-CRS-PatternList1-r16 | SetupRelease { LTE-CRS-PatternList-r16 } |
| OPTIONAL, -- Need M | |
| lte-CRS-PatternList2-r16 | SetupRelease { LTE-CRS-PatternList-r16 } |
| OPTIONAL, -- Need M | |

crs-RateMatch-PerCORESETPoolIndex-r16 ENUMERATED {enabled}

| | |
|---|---|
| OPTIONAL, -- Need R | |
| enableTwoDefaultTCI-States-r16 | ENUMERATED {enabled} |
| OPTIONAL, -- Need R | |

enableDefaultTCI-StatePerCoresetPoolIndex-r16 ENUMERATED { enabled }

| | |
|---|---|
| OPTIONAL, -- Need R | |
| enableBeamSwitch Timing-r16 | ENUMERATED {true} |
| OPTIONAL, -- Need R | |
| cbg-TxDiffTBsProcessingType1-r16 | ENUMERATED {enabled} |
| OPTIONAL, -- Need R | |
| cbg-TxDiffTBsProcessingType2-r16 | ENUMERATED { enabled } |
| OPTIONAL -- Need R | |
| ]] | |
| } | |

```
TABLE 18
        -  RateMatchPatternLTE-CRS
The IE RateMatchPatternLTE-CRS is used to configure a pattern to rate match around LTE
CRS. See TS 38.214 [19], clause 5.1.4.2.
                    RateMatch PatternLTE-CRS information element
-- ASN1START
-- TAG-RATEMATCHPATTERNLTE-CRS-START
RateMatchPatternLTE-CRS ::=  SEQUENCE {
  carrierFreqDL  INTEGER (0..16383),
  carrierBandwidthDL   ENUMERATED {n6, n15, n25, n50, n75, n100,
spare2, spare1 },
  mbsfn-SubframeConfigList   EUTRA-MBSFN-SubframeConfigList
OPTIONAL, -- Need M
  nrofCRS-Ports  ENUMERATED {n1, n2, n4},
  v-Shift   ENUMERATED {n0, n1, n2, n3, n4, n5}
}
LTE-CRS-PatternList-r16 ::=  SEQUENCE (SIZE (1..maxLTE-CRS-Patterns-r16))
OF RateMatchPatternLTE-CRS
-- TAG-RATEMATCHPATTERNLTE-CRS-STOP
-- ASN1STOP
RateMatch PatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause
5.1.4.2).
v-Shift
Shifting value v-shift in LTE to rate match around LTE CRS (see TS 38.214 [19], clause
5.1.4.2).
```

### [PDSCH: Regarding Frequency Resource Allocation]

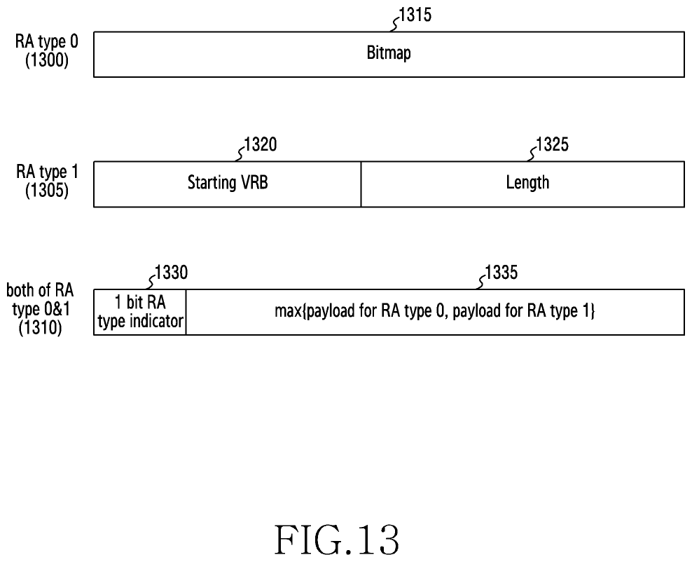

FIG. 13 illustrates an example of frequency domain resource allocation with regard to a physical downlink shared channel (PDSCH) in a wireless communication system according to an embodiment of the disclosure.

FIG. 13 illustrates three frequency domain resource allocation methods of type 0 1300, type 1 1301, and dynamic switch 1310 which can be configured through an upper layer in an NR wireless communication system.

Referring to FIG. 13, in the case in which a UE is configured to use only resource type 0 through upper layer signaling (1300), partial downlink control information (DCI) for allocating a PDSCH to the UE include a bitmap including NRBG bits. The conditions for this will be described again later. As used herein, NRBG refers to the number of resource block groups (RBGs) determined according to the BWP size allocated by a BWP indicator and upper layer parameter rbg-Size, as in Table 19 below, and data is transmitted in RBGs indicated as “1” by the bitmap.

TABLE 19

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

In the case in which the UE is configured to use only resource type 1 through upper layer signaling (1305), partial DCI includes frequency domain resource allocation information including [log₂(N_{RB}^{DL,BWP}(N_{RB}^{DL,BWP}+1)/2] bits. The conditions for this will be described again later. The base station may thereby configure a starting virtual resource block (starting VRB) 1320 and the length 1325 of a frequency domain resource allocated continuously therefrom.

In the case in which the UE is configured to use both resource type 0 and resource type 1 through upper layer signaling (1310), partial DCI for allocating a PDSCH to the corresponding UE includes frequency domain resource allocation information including as many bits as the larger value 1335 between the payload 1315 for configuring resource type 0 and the payload 1320 and 1325 for configuring resource type 1. The conditions for this will be described again later. One bit may be added to the foremost part (MSB) of the frequency domain resource allocation information inside the DCI. If the bit has the value of “0”, use of resource type 0 may be indicated, and if the bit has the value of “1”, use of resource type 1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 20 or Table 21 below may be transmitted from the base station to the UE. Obviously, the example given above is not limiting.

TABLE 20
PDSCH-TimeDomainResourceAllocationList information element

```
  PDSCH-TimeDomainResourceAllocationList ::= SEQUENCE (SIZE(1..maxNrofDL-
Allocations)) OF
  PDSCH-TimeDomainResourceAllocation
  PDSCH-TimeDomainResourceAllocation ::= SEQUENCE
      k0
INTEGER(0..32)
  OPTIONAL, -- Need S
    (PDCCH-to-PDSCH timing, slot unit)
    mappingType  ENUMERATED {typeA, typeB },
    (PDSCH mapping type)
    startSymbolAndLength  INTEGER (0..127)
    (start symbol and length of PDSCH)
}
```

TABLE 21
PUSCH-TimeDomainResourceAllocationList information element

```
  PUSCH-TimeDomainResourceAllocationList ::= SEQUENCE (SIZE(1..maxNrofUL-
Allocations)) OF
  PUSCH-TimeDomainResourceAllocation
  PUSCH-TimeDomainResourceAllocation ::=   SEQUENCE {
      k2   INTEGER(0..32)  OPTIONAL, --
Need S
      (PDCCH-to-PUSCH timing, slot unit)
      mappingType  ENUMERATED {typeA, typeB },
      (PUSCH mapping type)
      startSymbolAndLength  INTEGER (0..127)
      (start symbol and length of PUSCH)
  }
```

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

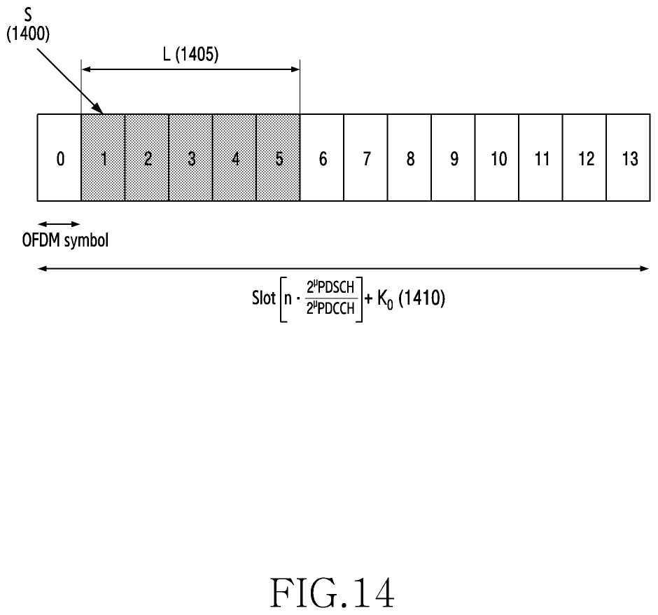

FIG. 14 illustrates an example of time domain resource allocation with regard to a PDSCH in a wireless communication system according to an embodiment of the disclosure.

Referring to FIG. 14, the base station may indicate the time domain location of a PDSCH resource according to the subcarrier spacing (SCS) (μ_{PDSCH}, μ_{PDCCH}) of a data channel and a control channel configured by using an upper layer, the scheduling offset (K0) value, and the OFDM symbol start location 1400 and length 1405 within one slot dynamically indicated through DCI.

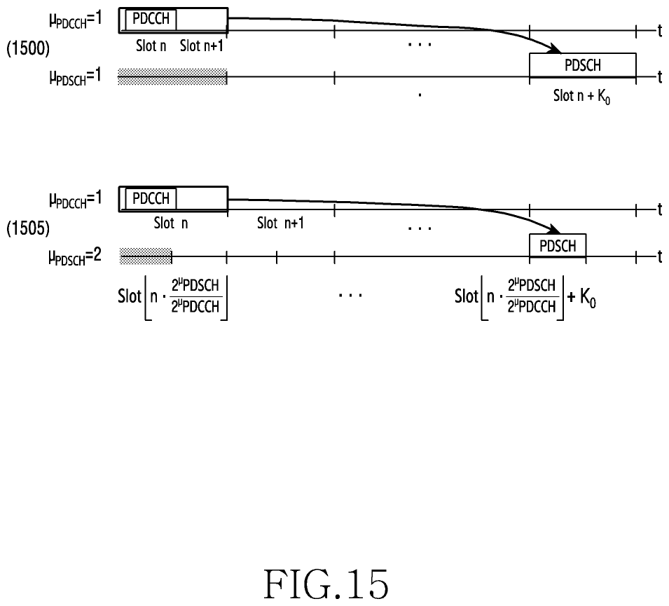

FIG. 15 illustrates an example of time domain resource allocation according to a subcarrier spacing with regard to a data channel and a control channel in a wireless communication system according to an embodiment of the disclosure.

Referring to FIG. 15, if the data channel and the control channel have the same subcarrier spacing (1500, μ_{PDSCH}≠μ_{PDCCH}), the slot number for data and that for control are identical, and the base station and the UE may accordingly generate a scheduling offset in conformity with a predetermined slot offset K0. On the other hand, if the data channel and the control channel have different subcarrier spacings (1505, μ_{PDSCH}≠μ_{PDCCH}), the slot number for data and that for control are different, and the base station and the UE may accordingly generate a scheduling offset in conformity with a predetermined slot offset K0 with reference to the subcarrier spacing of the PDCCH.

### [PDSCH: Processing Time]

Next, a PDSCH processing time (PDSCH processing procedure time) will be described. When the base station schedules the UE to transmit a PDSCH by using DCI format 1_0, 1_1 or 1_2, the UE may need a PDSCH processing time for receiving a PDSCH by applying a transmission method (modulation/demodulation and coding indication index (MCS), demodulation reference signal-related information, time and frequency resource allocation information, and the like) indicated through DCI. The PUSCH preparation procedure time is defined in NR in consideration thereof. The PUSCH preparation procedure time of the UE may follow Equation 3 given below.

$${T}_{proc , 1} = ( {N}_{1} + {d}_{1 , 1} + {d}_{2} ) ( 2048 + 144 ) {κ2}^{μ} {T}_{c} + {T}_{ext} \qquad Equation 3$$

Each parameter in T_{proc,1} described above in Equation 3 may have the following meaning

N₁: the number of symbols determined according to UE processing capability 1 or 2 based on the UE's capability and numerology μ. N₁ may have a value in Table 22 if UE processing capability 1 is reported according to the UE's capability report, and may have a value in Table 23 if UE processing capability 2 is reported, and if availability of UE processing capability 2 is configured though upper layer signaling. The numerology μ may correspond to the minimum value among μ_{PDCCH}, μ_{PDSCH}, μ_{UL} so as to maximize T_{proc,1}, and μ_{PDCCH}, μ_{PDSCH}, μ_{UL} may refer to the numerology of a PDCCH that scheduled a PDSCH, the numerology of the scheduled PDSCH, and numerology of an uplink channel in which a HARQ-ACK is to be transmitted.

TABLE 22
PDSCH processing time in the case of PDSCH processing capability 1

| | PDSCH decoding time N₁ [symbols] | |
|---|---|---|
| | If PDSCH mapping type A and B | If PDSCH mapping type A and B both do |
| | both correspond to dmrs- | not correspond to dmrs-AdditionalPosition = |
| | AdditionalPosition = pos0 | pos0 inside DMRS-DownlinkConfig |
| | inside DMRS-DownlinkConfig | which is upper layer signaling, or if no |
| μ | which is upper layer signaling | upper layer parameter is configured |
| 0 | 8 | N_{1, 0} |
| 1 | 10 | 13 |
| 2 | 17 | 20 |
| 3 | 20 | 24 |

TABLE 23
PDSCH processing time in the case
of PDSCH processing capability 2

| | PDSCH decoding time N₁ [symbols] |
|---|---|
| | If PDSCH mapping type A and B both correspond to |
| | dmrs-AdditionalPosition = pos0 inside DMRS-DownlinkConfig |
| μ | which is upper layer signaling |
| 0 | 3 |
| 1 | 4.5 |
| 2 | 9 for frequency range 1 |

k: 64
Tₑₓₜ: if the UE uses a shared spectrum channel access scheme, the UE may calculate Tₑₓₜ and apply the same to the PDSCH processing time. Otherwise, Tₑₓₜ is assumed to be 0.
If l₁ which represents the PDSCH DMRS location value is 12, N_{1,0} in [table 22] above has the value of 14, and otherwise has the value of 13.

With regard to PDSCH mapping type A, if the last symbol of the PDSCH is the i^{th} symbol in the slot in which the PDSCH is transmitted, and if i<7, d_{1,1} is then 7-i, and d_{1,1} is otherwise 0.
d₂: if a PUCCH having a high priority index temporally overlaps another PUCCH or a PUSCH having a low priority index, d₂ of the PUCCH having a high priority index may be configured as a value reported from the UE. Otherwise, d₂ is 0.

If PDSCH mapping type B is used with regard to UE processing capability 1, the d_{1,1} value may be determined by the number (L) of symbols of a scheduled PDSCH and the number of overlapping symbols between the PDCCH that schedules the PDSCH and the scheduled PDSCH, as follows.

$$\begin{matrix}If L \geq 7 , then {d}_{1 , 1} = 0. \\ If - L \geq 4 and L \leq 6 , then {d}_{1 , 1} = 7 - L \\ If L = 3 , then {d}_{1 , 1} = min ( d , 1 ) . \\ If L = 2 , then {d}_{1 , 1} = 3 + d .\end{matrix}$$

If PDSCH mapping type B is used with regard to UE processing capability 2, the d_{1,1} value may be determined by the number (L) of symbols of a scheduled PDSCH and the number of overlapping symbols between the PDCCH that schedules the PDSCH and the scheduled PDSCH, as follows.

$$\begin{matrix}If L \geq 7 , then {d}_{1 , 1} = 0. \\ If - L \geq 4 and L \leq 6 , then {d}_{1 , 1} = 7 - L . \\ If L = 2 ,\end{matrix}$$

If the scheduling PDCCH exists inside a CORESET including three symbols, and if the CORESET and the scheduled PDSCH have the same start symbol, then d_{1,1}=3.

Otherwise, d_{1,1}=d.

In the case of a UE supporting capability 2 inside a given serving cell, the PDSCH processing time based on UE processing capability 2 may be applied by the UE if processingType2Enabled (upper layer signaling) is configured as “enable” with regard to the corresponding cell.

If the location of the first uplink transmission symbol of a PUCCH including HARQ-ACK information (in connection with the corresponding location, K₁ defined as the HARQ-ACK transmission timepoint, a PUCCH resource used to transmit the HARQ-ACK, and the timing advance effect may be considered) does not start earlier than the first uplink transmission symbol that comes after the last symbol of the PDSCH over a time of T_{proc,1}, the UE needs to transmit a valid HARQ-ACK message. That is, the UE needs to transmit a PUCCH including a HARQ-ACK only if the PDSCH processing time is sufficient. The UE cannot otherwise provide the base station with valid HARQ-ACK information corresponding to the scheduled PDSCH. The T_{proc,1} may be used in the case of either a normal or an expanded CP. In the case of a PDSCH having two PDSCH transmission locations configured inside one slot, d_{1,1} is calculated with reference to the first PDSCH transmission location inside the corresponding slot.

### [PDSCH: Reception Preparation Time During Cross-Carrier Scheduling]

Next, in the case of cross-carrier scheduling in which the numerology (μ_{PDCCH}) by which a scheduling PDCCH is transmitted and the numerology (μ_{PDSCH}) by which a PDSCH scheduled by the corresponding PDCCH is transmitted are different from each other, the PDSCH reception reparation time (N_{pdsch}) of the UE defined with regard to the time interval between the PDCCH and PDSCH will be described.

If μ_{PDCCH}<μ_{PDSCH}, the scheduled PDSCH cannot be transmitted before the first symbol of the slot coming after N_{pdsch} symbols from the last symbol of the PDCCH that scheduled the corresponding PDSCH. The transmission symbol of the corresponding PDSCH may include a DM-RS.

If μ_{PDCCH}>μ_{PDSCH}, the scheduled PDSCH may be transmitted after N_{pdsch} symbols from the last symbol of the PDCCH that scheduled the corresponding PDSCH. The transmission symbol of the corresponding PDSCH may include a DM-RS.

TABLE 24
Npdsch according to scheduled PDCCH subcarrier spacing

| μ_{PDCCH} | N_{pdsch} [symbols] |
|---|---|
| 0 | 4 |
| 1 | 5 |
| 2 | 10 |
| 3 | 14 |

### [PDSCH: TCI State Activation MAC-CE]

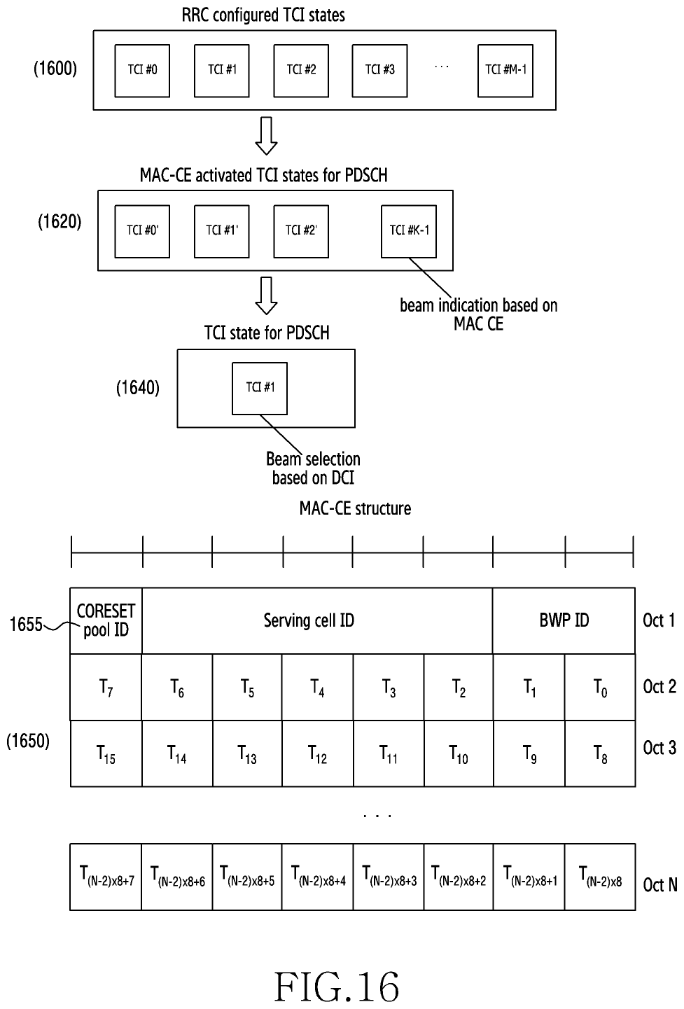

Next, a method for beam configuration with regard to a PDSCH will be described. FIG. 16 illustrates a process for beam configuration and activation with regard to a PDSCH. A list of TCI states regarding a PDSCH may be indicated through an upper layer list such as RRC (16-00). The list of TCI states may be indicated by tci-StatesToAddModList and/or tci-StatesToReleaseList inside a BWP-specific PDSCH-Config 1E, for example. Next, a part of the list of TCI states may be activated through a MAC-CE (16-20). The maximum number of activated TCI states may be determined by the capability reported by the UE. (16-50) illustrates an example of an MAC-CE structure for PDSCH TCI state activation/deactivation.

The meaning of respective fields inside the MAC CE and values configurable for respective fields are as follows.

- Serving Cell ID: This field indicates the identity of the Serving Cell for which the
MAC CE applies. The length of the field is 5 bits. If the indicated Serving Cell is configured
as part of a simultaneousTCI-UpdateList1 or simultaneousTCI-UpdateList2 as specified in
TS 38.331 [5], this MAC CE applies to all the Serving Cells configured in the set
simultaneousTCI-UpdateList1 or simultaneousTCI-UpdateList2, respectively;
- BWP ID: This field indicates a DL BWP for which the MAC CE applies as the
codepoint of the DCI bandwidth part indicator field as specified in TS 38.212 [9]. The length
of the BWP ID field is 2 bits. This field is ignored if this MAC CE applies to a set of Serving
Cells;
- Tᵢ (TCI state ID): If there is a TCI state with TCI-StateId i as specified in TS 38.331
[5], this field indicates the activation/deactivation status of the TCI state with TCI-StateId i,
otherwise MAC entity shall ignore the Ti field. The Ti field is set to 1 to indicate that the TCI
state with TCI-StateId i shall be activated and mapped to the codepoint of the DCI
Transmission Configuration Indication field, as specified in TS 38.214 [7]. The Ti field is set
to 0 to indicate that the TCI state with TCI-StateId i shall be deactivated and is not mapped
to the codepoint of the DCI Transmission Configuration Indication field. The codepoint to
which the TCI State is mapped is determined by its ordinal position among all the TCI States
with Ti field set to 1, i.e. the first TCI State with Tᵢ field set to 1 shall be mapped to the
codepoint value 0, second TCI State with Ti field set to 1 shall be mapped to the codepoint
value 1 and so on. The maximum number of activated TCI states is 8;
- CORESET Pool ID: This field indicates that mapping between the activated TCI
states and the codepoint of the DCI Transmission Configuration Indication set by field Ti is
specific to the ControlResourceSetId configured with CORESET Pool ID as specified in TS
38.331 [5]. This field set to 1 indicates that this MAC CE shall be applied for the DL
transmission scheduled by CORESET with the CORESET pool ID equal to 1, otherwise, this
MAC CE shall be applied for the DL transmission scheduled by CORESET pool ID equal to
0. If the coresetPoolIndex is not configured for any CORESET, MAC entity shall ignore the
CORESET Pool ID field in this MAC CE when receiving the MAC CE. If the Serving Cell
in the MAC CE is configured in a cell list that contains more than one Serving Cell, the
CORESET Pool ID field shall be ignored when receiving the MAC CE.

### [Regarding SRS]

Next, an uplink channel estimation method using sounding reference signal (SRS) transmission of a UE will be described. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange upper signaling information as follows, in order to transfer information regarding the SRS resource set.
srs-ResourceSetId: an SRS resource set index
srs-ResourceIdList: a set of SRS resource indices referred to by SRS resource sets
resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources, and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicityAndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicityAndOffset configured for the SRS resource.

In addition, the spatial domain transmission filter applied to the transmitted SRS resource may refer to spatial relation info configured for the SRS resource, or may refer to associated CSI-RS configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource may follow resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set.

Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in view of UE processing capability that follows the UE's capability with reference to the UE's PUSCH preparation procedure time. In addition, if the place of use of the SRS resource set is configured as “codebook” or “antennaSwitching” in consideration of the place of use of the SRS resource set including the transmitted SRS resource, the minimum time interval may be determined as N2 symbols, and ifthe place of use of the SRS resource set is configured as “nonCodebook” or “beamManagement”, the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 25

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |
| OPTIONAL, -- Need R | |
| transmissionComb | CHOICE { |
| n2 | SEQUENCE { |
| combOffset-n2 | INTEGER (0..1), |
| cyclicShift-n2 | INTEGER (0..7) |
| }, | |
| n4 | SEQUENCE { |
| combOffset-n4 | INTEGER (0..3), |
| cyclicShift-n4 | INTEGER (0..11) |
| } | |
| }, | |
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED { neither, groupHopping, |
| quenceHopping }, | |
| resourceType | CHOICE { |
| aperiodic | SEQUENCE { |
| ... | |
| }, | |
| semi-persistent | SEQUENCE { |
| periodicity AndOffset-sp | SRS-Periodicity AndOffset, |
| ... | |
| }, | |
| periodic | SEQUENCE |
| periodicity AndOffset-p | SRS-Periodicity AndOffset, |
| ... | |
| } | |
| }, | |
| sequenceId | INTEGER (0..1023), |
| spatialRelationInfo | SRS-SpatialRelationInfo |
| OPTIONAL, -- Need R | |
| ... | |
| } | |

Configuration information spatialRelationInfo in Table 25 above may be applied, with reference to one reference signal, to a beam used for SRS transmission corresponding to beam information of the corresponding reference signal. For example, configuration of spatialRelationInfo may include information as in Table 26 below. Obviously, the example given below is not limiting.

TABLE 26

| | |
|---|---|
| SRS-SpatialRelationInfo ::= | SEQUENCE { |
| servingCellId | ServCellIndex OPTIONAL, -- Need S |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |
| } | |
| } | |
| } | |

Referring to the spatialRelationInfo configuration, an SS/PBCH block index, CSI-RS index, or SRS index may be configured as the index of a reference signal to be referred to in order to use beam information of a specific reference signal. Upper signaling referenceSignal corresponds to configuration information indicating which reference signal's beam information is to be referred to for corresponding SRS transmission, ssb-Index may refer to the index of an SS/PBCH block, csi-RS-Index may refer to the index of a CSI-RS, and srs may refer to the index of an SRS. If upper signaling referenceSignal has a configured value of “ssb-Index”, the UE may apply the reception beam which was used to receive the SS/PBCH block corresponding to ssb-Index as the transmission beam for the corresponding SRS transmission. If upper signaling referenceSignal has a configured value of “csi-RS-Index”, the UE may apply the reception beam which was used to receive the CSI-RS corresponding to csi-RS-Index as the transmission beam for the corresponding SRS transmission. If upper signaling referenceSignal has a configured value of “ssb-Index”, the UE may apply the reception beam which was used to receive the SS/PBCH block corresponding to ssb-Index as the transmission beam for the corresponding SRS transmission.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 27 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 16 through upper signaling. If PUSCH transmission is operated by a configured grant, parameters applied to the PUSCH transmission are applied through configuredGrantConfig (upper signaling) in Table 27 except for dataScramblingIdentityPUSCH, txConfig, codebookSubset, maxRank, and scaling of UCI-OnPUSCH, which are provided by pusch-Config (upper signaling) in Table 28. If provided with transformPrecoder inside configuredGrantConfig (upper signaling) in Table 27, the UE applies tp-pi2BPSK inside pusch-Config in Table 28 to PUSCH transmission operated by a configured grant. Obviously, the example given above is not limiting.

TABLE 27

| | |
|---|---|
| ConfiguredGrantConfig ::= | SEQUENCE { |
| frequency Hopping | ENUMERATED {intraSlot, interSlot} |
| OPTIONAL, -- Need S, | |
| cg-DMRS-Configuration | DMRS-UplinkConfig, |
| mcs-Table | ENUMERATED { qam256, qam64LowSE} |
| OPTIONAL, -- Need S | |
| mcs-TableTransformPrecoder | ENUMERATED {qam256, qam64LowSE} |
| OPTIONAL, -- Need S | |
| uci-OnPUSCH | SetupRelease { CG-UCI-OnPUSCH } |
| OPTIONAL, -- Need M | |
| resourceAllocation | ENUMERATED { resourceAllocation Type0, |

resourceAllocationType1, dynamicSwitch },

| | |
|---|---|
| rbg-Size | ENUMERATED { config2} |
| OPTIONAL, -- Need S | |
| powerControlLoopToUse | ENUMERATED {n0, n1}, |
| p0-PUSCH-Alpha | P0-PUSCH-AlphaSetId, |
| transformPrecoder | ENUMERATED { enabled, disabled} |
| OPTIONAL, -- Need S | |
| nrofHARQ-Processes | INTEGER(1..16), |
| repK | ENUMERATED {n1, n2, n4, n8 }, |
| repK-RV | ENUMERATED {s1-0231, s2-0303, s3-0000} |
| OPTIONAL, -- Need R | |
| periodicity | ENUMERATED { |
| | sym2, sym7, sym1x14, sym2x14, sym4x14, sym5x14, |

sym8x14, sym 10x14, sym16x14, sym20x14,

sym32x14, sym40x14, sym64x14, sym80x14,

sym128x14, sym160x14, sym256x14, sym320x14, sym512x14,

| | |
|---|---|
| | sym640x14, sym1024x14, sym1280x14, sym2560x14, |
| sym5120x14, | |
| | sym6, sym1x12, sym2x12, sym4x12, sym5x12, |

sym8x12, sym10x12, sym16x12, sym20x12, sym32x12,

sym40x12, sym64x12, sym80x12, sym128x12,

sym160x12, sym256x12, sym320x12, sym512x12, sym640x12,

| | |
|---|---|
| | sym1280x12, sym2560x12 |
| }, | |
| configuredGrantTimer | INTEGER (1..64) |
| OPTIONAL, -- Need R | |
| rrc-ConfiguredUplinkGrant | SEQUENCE { |
| timeDomainOffset | INTEGER (0..5119), |
| timeDomainAllocation | INTEGER (0..15), |
| frequency DomainAllocation | BIT STRING (SIZE(18)), |
| antennaPort | INTEGER (0..31), |
| dmrs-SeqInitialization | INTEGER (0..1) |
| OPTIONAL, -- Need R | |
| precodingAndNumberOfLayers | INTEGER (0..63), |
| srs-ResourceIndicator | INTEGER (0..15) |
| OPTIONAL, -- Need R | |
| mcsAndTBS | INTEGER (0..31), |
| frequency HoppingOffset | INTEGER (1 .. |
| maxNrofPhysicalResourceBlocks-1) | OPTIONAL, -- Need R |
| pathlossReferenceIndex | INTEGER (0..maxNrofPUSCH- |
| PathlossReferenceRSs-1), | |
| ... | |
| } | |
| OPTIONAL, -- Need R | |
| ... | |
| } | |

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 15, which is upper signaling, is “codebook” or “nonCodebook”.

As described above, PUSCH transmission may be dynamically scheduled through DCI format 0_0 or 0_1, and may be operated semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 28, the UE does not expect scheduling through DCI format 0_1.

TABLE 28

| | |
|---|---|
| PUSCH-Config ::= | SEQUENCE { |
| dataScramblingIdentityPUSCH | INTEGER (0..1023) |
| OPTIONAL, -- Need S | |
| txConfig | ENUMERATED {codebook, nonCodebook} |
| OPTIONAL, -- Need S | |
| dmrs-UplinkForPUSCH-MappingTypeA | SetupRelease { DMRS-UplinkConfig } |
| OPTIONAL, -- Need M | |
| dmrs-UplinkForPUSCH-MappingTypeB | SetupRelease { DMRS-UplinkConfig } |
| OPTIONAL, -- Need M | |
| pusch-PowerControl | OPTIONAL, -- |
| Need M | |
| frequency Hopping | ENUMERATED {intraSlot, interSlot} |
| OPTIONAL, -- Need S | |
| frequency HoppingOffsetLists | SEQUENCE (SIZE (1..4)) OF INTEGER (1 .. |
| maxNrofPhysicalResourceBlocks-1) | |
| OPTIONAL, -- Need M | |

| | |
|---|---|
| resourceAllocation | ENUMERATED { resourceAllocationType0, |

resourceAllocationType1, dynamicSwitch },

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |
| OPTIONAL, -- Need S | |
| mcs-Table | ENUMERATED {qam256, qam64LowSE} |
| OPTIONAL, -- Need S | |
| mcs-TableTransformPrecoder | ENUMERATED { qam256, qam64LowSE} |
| OPTIONAL, -- Need S | |
| transformPrecoder | ENUMERATED {enabled, disabled} |
| OPTIONAL, -- Need S | |
| codebookSubset | ENUMERATED |

{fully AndPartialAndNonCoherent, partialAndNonCoherent, nonCoherent}

| | |
|---|---|
| OPTIONAL, -- Cond codebookBased | INTEGER (1..4) |
| maxRank | |
| OPTIONAL, -- Cond codebookBased | |
| rbg-Size | ENUMERATED { config2} |
| OPTIONAL, -- Need S | |
| uci-OnPUSCH | SetupRelease { UCI-OnPUSCH} |
| OPTIONAL, -- Need M | |
| tp-pi2BPSK | ENUMERATED {enabled } |
| OPTIONAL, -- Need S | |
| ... | |
| } | |

Hereinafter, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent” as UE capability, the UE may not expect that the value of codebookSubset (upper signaling) will be configured as “fullyAndPartialAndNonCoherent”. In addition, if the UE reported “nonCoherent” as UE capability, UE may not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE may expect that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Hereinafter, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 11) is not “00”. The corresponding DCI should not indicate cross carrier or cross BWP scheduling. In addition, if the value of SRS request indicates the existence of a NZP CSI-RS, the NZP CSI-RS may be positioned in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE may not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”, and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### [PUSCH: Preparation Procedure Time]

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow Equation 4 given below.

$${T}_{proc , 2} = max ( ( {N}_{2} + {d}_{2 , 1} + {d}_{2} ) ( 2048 + 144 ) {κ2}^{- μ} {T}_{c} + {T}_{ext} + {T}_{switch} , {d}_{2 , 2} ) \qquad Equation 4$$

Each parameter in T_{proc,2} described above in Equation 4 may have the following meaning.

N₂: the number of symbols determined according to UE processing capability 1 or 2, based on the UE's capability, and numerology μ. N₂ may have a value in Table 40 if UE processing capability 1 is reported according to the UE's capability report, and may have a value in Table 41 if UE processing capability 2 is reported, and if availability of UE processing capability 2 is configured through upper layer signaling.

TABLE 29

| μ | PUSCH preparation time N₂ [symbols] |
|---|---|
| 0 | 10 |
| 1 | 12 |
| 2 | 23 |
| 3 | 36 |

TABLE 30

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.
T_{c}: has 1/(Δfₘₐₓ·N_{f}), Δfₘₐₓ=480·10³ Hz, N_{f}=4096.
d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, T_{switch} is assumed to be 0.

The base station and the UE may determine that the PUSCH preparation procedure time is insufficient if the first symbol of a PUSCH starts earlier than the first uplink symbol in which a CP starts after Tproc,2 from the last symbol of a PDCCH including DCI that schedules the PUSCH, in view of the influence of timing advance between the uplink and the downlink and time domain resource mapping information of the PUSCH scheduled through the DCI. Otherwise, the base station and the UE may determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repeated Transmission]

Hereinafter, repeated transmission of an uplink data channel in a 5G system will be described in detail. A 5G system supports two types of methods for repeatedly transmitting an uplink data channel, PUSCH repeated transmission type A and PUSCH repeated transmission type B. One of PUSCH repeated transmission type A and type B may be configured for a UE through upper layer signaling.

### PUSCH Repeated Transmission Type A

As described above, the symbol length of an uplink data channel and the location of the start symbol may be determined by a time domain resource allocation method in one slot, and a base station may notify a UE of the number of repeated transmissions through upper layer signaling (for example, RRC signaling) or L1 signaling (for example, DCI).

Based on the number of repeated transmissions received from the base station, the UE may repeatedly transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE may omit uplink data channel transmission, but may count the number of repeated transmissions of the uplink data channel.

### PUSCH Repeated Transmission Type B

As described above, the symbol length of an uplink data channel and the location of the start symbol may be determined by a time domain resource allocation method in one slot, and a base station may notify a UE of the number of repeated transmissions (numberofrepetitions) through upper layer signaling (for example, RRC signaling) or L1 signaling (for example, DCI).

The nominal repetition of the uplink data channel is determined as follows, based on the previously configured start symbol and length of the uplink data channel. The slot in which the n^{th} nominal repetition starts is given by

$${K}_{s} + ⌊ \frac{S + n \cdot L}{{N}_{symb}^{slot}} ⌋ ,$$

and the symbol starting in that slot is given by mod(S+n·L, N_{symb}^{slot}). The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by mod(S+(n+1)·L−1, N_{symb}^{slot}). In this regard, n=0, . . . , numberofrepetitions-1, S refers to the start symbol of the configured uplink data channel, and L refers to the symbol length of the configured uplink data channel. Kₛ refers to the slot in which PUSCH transmission starts, and N_{symb}^{slot} refers to the number of symbols per slot.

The UE may determine an invalid symbol for PUSCH repeated transmission type B. A symbol configured as a downlink by tdd-UL-DL-ConfigurationCommon or tdd-UL-DL-ConfigurationDedicated may be determined as the invalid symbol for PUSCH repeated transmission type B. Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 may represent the invalid symbol. Additionally, the cycle and pattern of the bitmap may be configured through the upper layer parameter (for example, InvalidSymbolPattern). If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE may apply the invalid symbol pattern. If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE may apply the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition may include a set of consecutive valid symbols available for PUSCH repeated transmission type B in one slot.

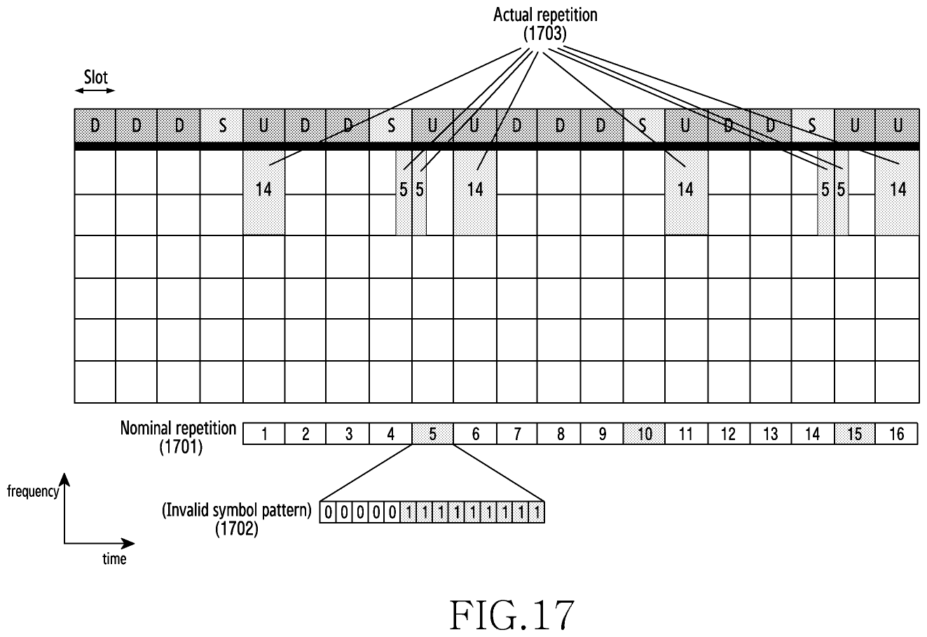

FIG. 17 illustrates an example of PUSCH repeated transmission type B in a wireless communication system according to an embodiment of the disclosure. Referring to FIG. 17, the UE may receive the following configurations: the start symbol S of an uplink data channel is 0, the length L of the uplink data channel is 14, and the number of repeated transmissions is 16. In this case, nominal repetitions may appear in 16 consecutive slots (1701). Thereafter, the UE may determine that the symbol configured as a downlink symbol in each nominal repetition 1701 is an invalid symbol. The UE may determine that symbols configured as 1 in the invalid symbol pattern 1702 are invalid symbols. If valid symbols other than invalid symbols in respective nominal repetitions constitute one or more consecutive symbols in one slot, they are configured and transmitted as actual repetitions (1703).

In addition, with regard to PUSCH repeated transmission, additional methods may be defined in NR Release 16 with regard to UL grant-based PUSCH transmission and configured grant-based PUSCH transmission, across slot boundaries, as follows:

Method 1 (mini-slot level repetition): through one UL grant, two or more PUSCH repeated transmissions may be scheduled inside one slot or across the boundary of consecutive slots. In connection with method 1, time domain resource allocation information inside DCI may indicate resources of the first repeated transmission. In addition, time domain resource information of remaining repeated transmissions may be determined according to time domain resource information of the first repeated transmission, and the uplink or downlink direction determined with regard to each symbol of each slot. Each repeated transmission may occupy consecutive symbols.

Method 2 (multi-segment transmission): through one UL grant, two or more PUSCH repeated transmissions may be scheduled in consecutive slots. Transmission no. 1 may be designated with regard to each slot, and the start point or repetition length may differ between respective transmission. In method 2, time domain resource allocation information inside DCI may indicate the start point and repetition length of all repeated transmissions. In the case of performing repeated transmissions inside a single slot through method 2, if there are multiple bundles of consecutive uplink symbols in the corresponding slot, respective repeated transmissions may be performed with regard to respective uplink symbol bundles. If there is a single bundle of consecutive uplink symbols in the corresponding slot, PUSCH repeated transmission may be performed once according to the method of NR Release 15.

Method 3: two or more PUSCH repeated transmissions are scheduled in consecutive slots through two or more UL grants. Transmission no. 1 may be designated with regard to each slot, and the nth UL grant may be received before PUSCH transmission scheduled by the (n−1)th UL grant is over.

Method 4: through one UL grant or one configured grant, one or multiple PUSCH repeated transmissions inside a single slot, or two or more PUSCH repeated transmissions across the boundary of consecutive slots may be supported. The number of repetitions indicated to the UE by the base station is only a nominal value, and the UE may actually perform a larger number of PUSCH repeated transmissions than the nominal number of repetitions. Time domain resource allocation information inside DCI or configured grant may refer to resources of the first repeated transmission indicated by the base station. Time domain resource information of remaining repeated transmissions may be determined with reference to resource information of the first repeated transmission and the uplink or downlink direction of symbols. If time domain resource information of a repeated transmission indicated by the base station spans a slot boundary or includes an uplink/downlink switching point, the corresponding repeated transmission may be divided into multiple repeated transmissions. One repeated transmission may be included in one slot with regard to each uplink period.

### [PUSCH: Frequency Hopping Process]

Hereinafter, frequency hopping of a physical uplink shared channel (PUSCH) in a 5G system will be described in detail.

5G may support two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported. Obviously, the example given above is not limiting.

The intra-slot frequency hopping method supported in PUSCH repeated transmission type A may include a method in which a UE transmits allocated resources in the frequency domain, after changing the same by a configured frequency offset, by two hops in one slot. The start RB of each hop in connection with intra-slot frequency hopping may be expressed by Equation 5 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad Equation 5$$

In Equation 5, i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an upper layer parameter. The number of symbols of the first hop may be represented by └N_{symb}^{PUSCH,s}/2┘, and number of symbols of the second hop may be represented by N_{symb}^{PUSCH,s}−└N_{symb}^{PUSCH,s}/2┘. N_{symb}^{PUSCH,s} is the length of PUSCH transmission in one slot and is expressed by the number of OFDM symbols.

Next, the inter-slot frequency hopping method supported in PUSCH repeated transmission types A and B is a method in which the UE transmits allocated resources in the frequency domain, after changing the same by a configured frequency offset, in each slot. The start RB during a slot in connection with inter-slot frequency hopping may be expressed by Equation 6 below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad Equation 6$$

In Equation 6, nₛ^{μ} denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an upper layer parameter.

The inter-repetition frequency hopping method supported in PUSCH repeated transmission type B may be a method in which resources allocated in the frequency domain regarding one or multiple actual repetitions in each nominal repetition are moved by a configured frequency offset and then transmitted. The index RBstart(n) of the start RB in the frequency domain regarding one or multiple actual repetitions in the nth nominal repetition may follow Equation 7 given below.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad Equation 7$$

In Equation 7, n denotes the index of nominal repetition, and RB_{offset} denotes an RB offset between two hops through an upper layer parameter.

### [Regarding UE Capability Report]

In LTE and NR, a UE may perform a procedure in which, while being connected to a serving base station, the UE reports capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA—NR dual connectivity (EN-DC). The UE capability enquiry message may be transmitted initially after the UE is connected to the base station, in general, but may be requested in any condition if needed by the base station.

According to an embodiment, upon receiving the UE capability report request from the base station, the UE may configure UE capability according to band information and RAT type requested by the base station. The method in which the UE configures UE capability in an NR system is summarized below:

1. If the UE receives a list regarding LTE and/or NR bands from the base station at a UE capability request, the UE may construct band combinations (BCs) regarding EN-DC and NR standalone (SA). That is, the UE may configure a candidate list of BCs regarding EN-DC and NR SA, based on bands received from the base station at a request through FreqBandList. In addition, bands may have priority in the order described in FreqBandList.

2. If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.

3. The UE may then remove fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step may be applied in MR-DC as well, that is, LTE bands may also be applied. BCs remaining after the above step may constitute the final “candidate BC list”.

4. The UE may select BCs appropriate for the requested RAT type from the final “candidate BC list” and select BCs to report. In this step, the UE may configure supportedBandCombinationList in a determined order. That is, the UE may configure BCs and UE capability to report according to a preconfigured rat-Type order. (nr->eutra-nr->eutra). In addition, the UE may configure featureSetCombination regarding the configured supportedBandCombinationList, and configure a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be provided from feature set combinations of containers of UE-NR-Capabilities and UE-MRDC-Capabilities.

5. If the requested RAT type is eutra-nr and has an influence, featureSetCombinations may be included on both containers of UE-MRDC-Capabilities and UE-NR-Capabilities. However, the feature set of NR may be included only in UE-NR-Capabilities.

After the UE capability is configured, the UE may transfer a UE capability information message including the UE capability to the base station. The base station may perform scheduling and transmission/reception management appropriate for the UE, based on the UE capability received from the UE.

3GPP RAN1 is a scheme for reducing transmission/reception load of control information used for beam control and simplifying operations of a UE and a base station to reduce total complexity and may define the use of a common beam, and the common beam may be operated by designating a common TCI state.

In the use of a common beam, the base station may transmit, to the UE, information on a beam commonly used for transmission and reception of one or more channels or signals in the form of a TCI index and a TCI state, and accordingly, the base station may perform beam control through transmission of a small number of pieces of beam control information compared to the number of channels and signals which should be transmitted and received by the UE.

The UE may acquire information on the TCI state from the received beam control information and, when the acquired TCI state value is different from a common TCI state value remembered by the UE, may change the common TCI state value to the acquired TCI state value, and transmit an Ack signal to the base station so as to notify the base station that the TCI state value has been successfully received. According to an embodiment of the disclosure, the changed common TCI state value may then be applied to transmission and reception of a channel and a signal between the UE and the base station.

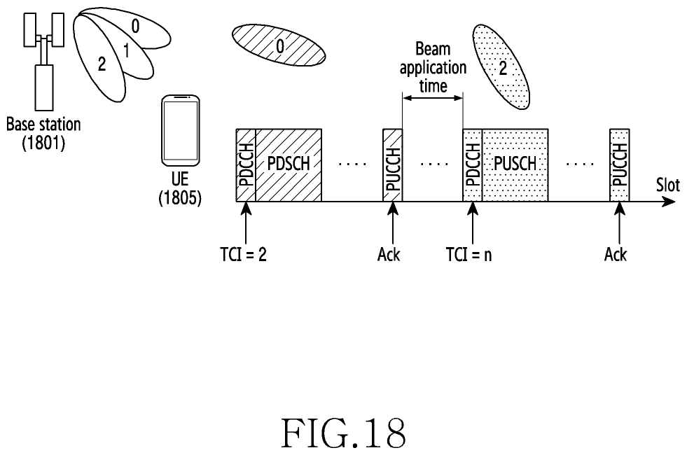

FIG. 18 illustrates a scheme for controlling a transmission and reception beam of a channel or a signal based on a common TCI state according to an embodiment of the disclosure.

FIG. 18 illustrates an example of application of a common TCI state, in which transmission and reception beams of a PDCCH/PDSCH/PUCCH and a PUSCH are controlled by a designated common TCI state.

A UE 1805 may perform communication through one transmission and reception node. Therefore, the UE 1805 may receive information on one beam through one piece of TCI state information. For example, as shown in FIG. 18, a base station 1801 may schedule a PDSCH through one PDCCH, and perform beam control for PDSCH reception and PUCCH transmission through one TCI state value (TCI=0) (common TCI State value).

In addition, when the base station 1801 provides a new TCI State value (TCI=2) and the new TCI state value (TCI=2) is different from a common TCI state value (TCI=0) stored in the UE, the UE 1805 may transmit an Ack signal to the base station 1801, and thus notify the base station 1801 that a TCI state value has been successfully received, and simultaneously change the stored common TCI state value (TCI=0) to the new TCI state value (TCI=2).

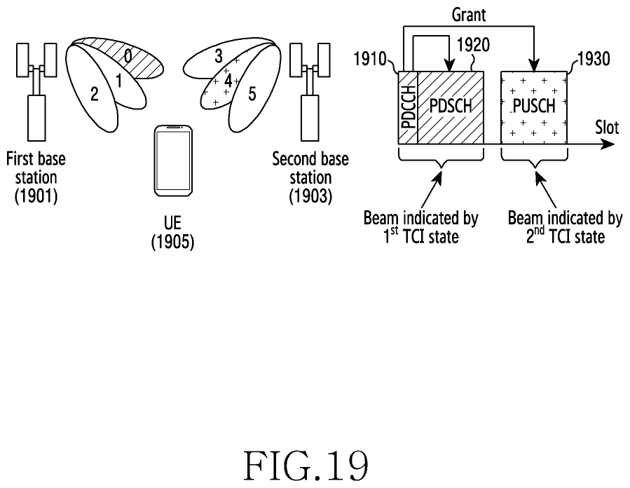

FIG. 19 illustrates a method of providing information on multiple beams through multiple pieces of TCI information according to an embodiment of the disclosure.

When a UE 1905 performs communication through multiple transmission and reception nodes, communication between the UE 1905 and each node is performed through different beams, and therefore, the UE may receive information on multiple beams through multiple pieces of TCI state information. For example, as shown in FIG. 19, when a first base station 1901 schedules reception of two PDSCHs 1920 and 1930 through transmission of one PDCCH 1910, the UE 1905 is required to receive one TCI state value for reception of a first PDSCH 1920 and the PDCCH 1910, and another TCI state value for reception of a second PDSCH 1930. Therefore, the existing common TCI state-based beam control technique that performs beam control through one TCI state value is unable to support multi-node communication.

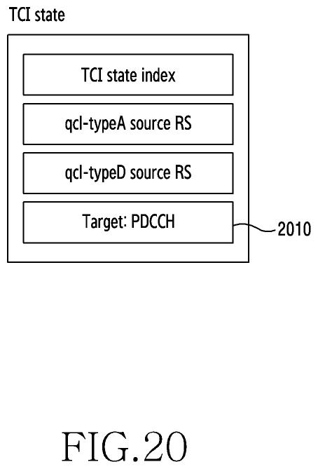

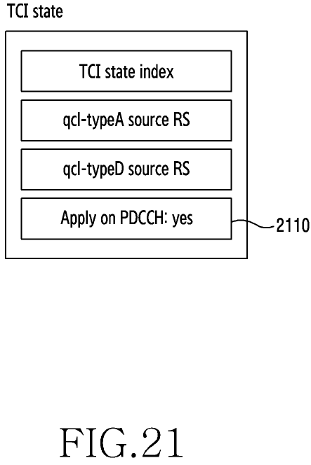

FIGS. 20 and 21 illustrate a method of configuring a channel to which a common TCI state is applied, according to an embodiment of the disclosure.

According to an embodiment of the disclosure, in the case of supporting a multi-transmission reception point (m-TRP) (hereinafter, interchangeably used with a multi-node) communication, when each TCI state available as a common TCI state is configured, a base station may additionally configure information on a channel to which each TCI state is applicable.

For example, in the case of configuring a TCI state as shown in FIG. 20, the base station may configure information on a channel for which beam control or change is indicated by a TCI state (e.g., information on a target channel included in a TCI State) 2010 or may configure information 2110 on whether a corresponding TCI state indicates beam control with respect to a specific channel as shown in FIG. 21.

In addition, in the case of configuring a target channel and an RS of each TCI state in the scheme of FIGS. 20 and 21, the base station may separately configure or define a correlation between each target channel and RS. For example, the base station may define or configure that all TCI states which target beam control of a PDCCH also target beam control of a PDSCH or a PUSCH.

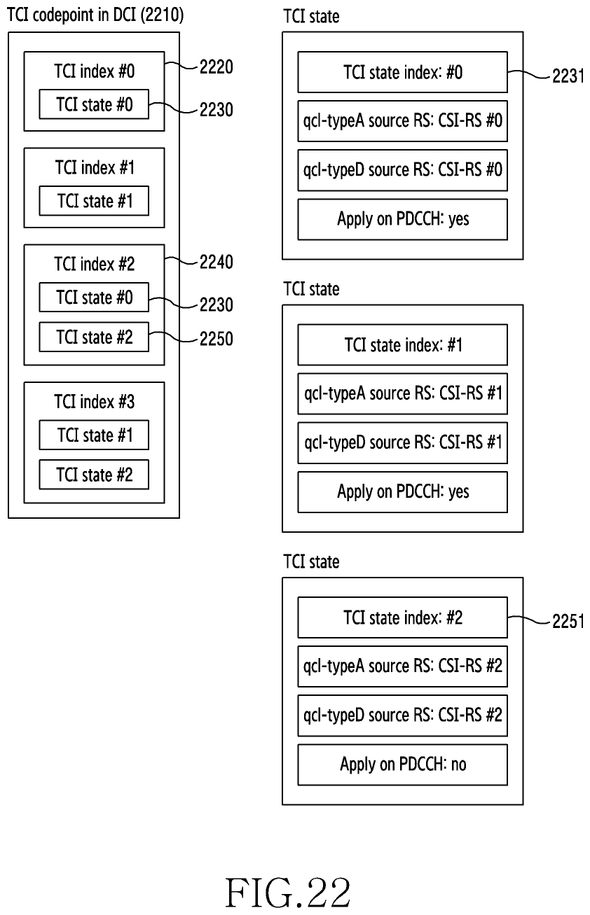

FIG. 22 illustrates a scheme for configuring a TCI index and a TCI State according to an embodiment of the disclosure.

FIG. 22 illustrates an example of a scheme for configuring a TCI index and a TCI state according to the scheme of FIG. 21. The example of FIG. 22 is an example of a case where one TCI index indicates one or more TCI states, but embodiments of the disclosure are not limited to the above examples, and may include both a case where one TCI index is configured to indicate only one TCI state and a case where one TCI index is configured to indicate only two or more TCI States.

Referring to FIG. 22, a base station may configure a TCI index through a TCI codepoint 2210 in DCI. The TCI index may indicate a TCI State.

For example, TCI index #0 2220 may indicate TCI State #0 2230. TCI State #0 2230 corresponds to TCI State index #0 2231, and a TCI State according to TCI State index #0 may be applied to beam control of a PDCCH. TCI index #2 2240 may indicate TCI State #0 2230 and TCI State #2 2250. TCI State #2 2240 corresponds to TCI State index #2 2251, and a TCI State according to TCI State index #2 2251 may not be applied to beam control of a PDCCH.

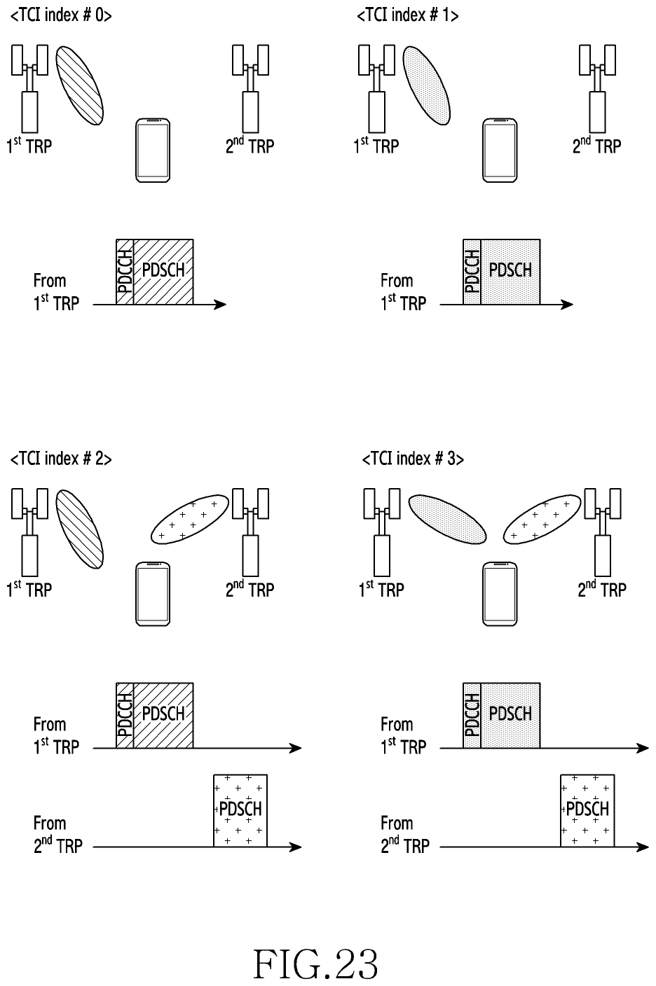

FIG. 23 illustrates a beam and TRP indication method by a UE operating in an m-TRP system, according to an embodiment of the disclosure.

FIG. 23 illustrates an example of a beam and TRP indication method by a UE operating in an m-TRP system through the TCI index and TCI state configuration scheme of FIG. 22. FIG. 23 assumes a case where a TCI state indicating a beam of a PDCCH is configured or defined so as to also indicate TCI states of another channel and RS.

In the examples of FIGS. 22 and 23, when a UE receives a TCI index indicating two TCI states and applies the TCI index to PDSCH reception, the UE may identify that simultaneous or sequential PDSCH reception through two beams has been indicated. In addition, an operation in which each beam is transmitted from each TRP may also be indicated.

Both two TCI states may be indicated through one TCI index. In addition, when two TCI states are simultaneously indicated, both one TCI State that controls a beam for a predetermined channel and one TCI State that does not control a beam for a predetermined channel may be simultaneously indicated. Referring to FIG. 22, TCI index #2 2240 indicates both TCI State #0 2230 and TCI State #2 2250. TCI State #0 2230 is a TCI State that controls a beam for a PDCCH, and TCI State #2 2250 is a TCI State that does not control a beam for a PDCCH. That is, both one TCI state that controls a beam for a PDCCH and another TCI state that does not control a PDCCH beam may be indicated.

In addition, FIG. 23 illustrates communication between a TRP and a UE according to the TCI codepoint of the DCI of FIG. 22. As in the example of FIG. 23, the TCI indexes of FIG. 22 do not indicate both two TCI States supporting beam control of a PDCCH, and thus an m-TRP (multi-TRP) operation of a PDSCH and switching between an s-TRP (single-TRP) operation and the m-TRP operation may be indicated, but switching between an m-TRP operation of a PDCCH or an s-TRP operation of a PDCCH and the m-TRP operation may not be indicated.

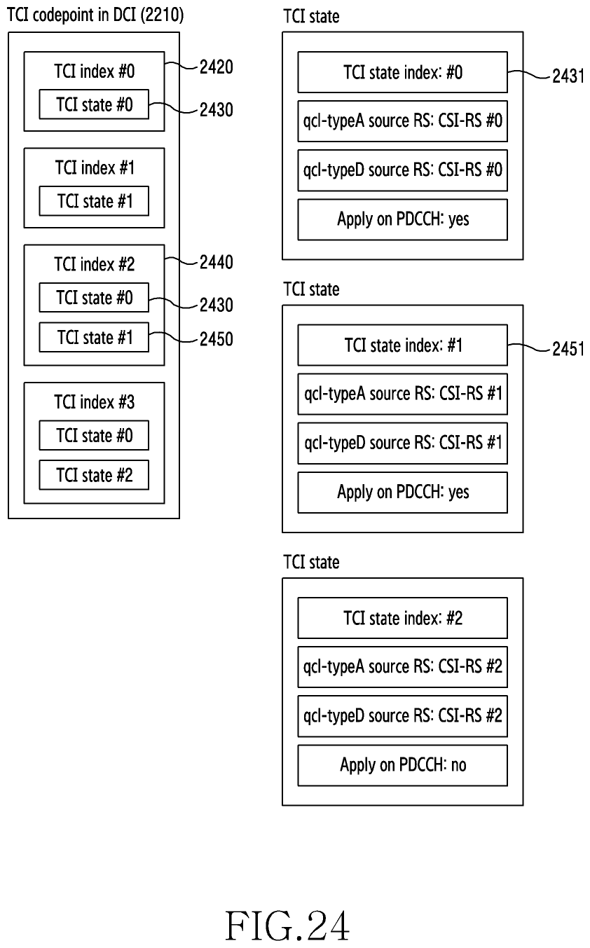

FIG. 24 illustrates a scheme for configuring a TCI index and a TCI State according to an embodiment of the disclosure.

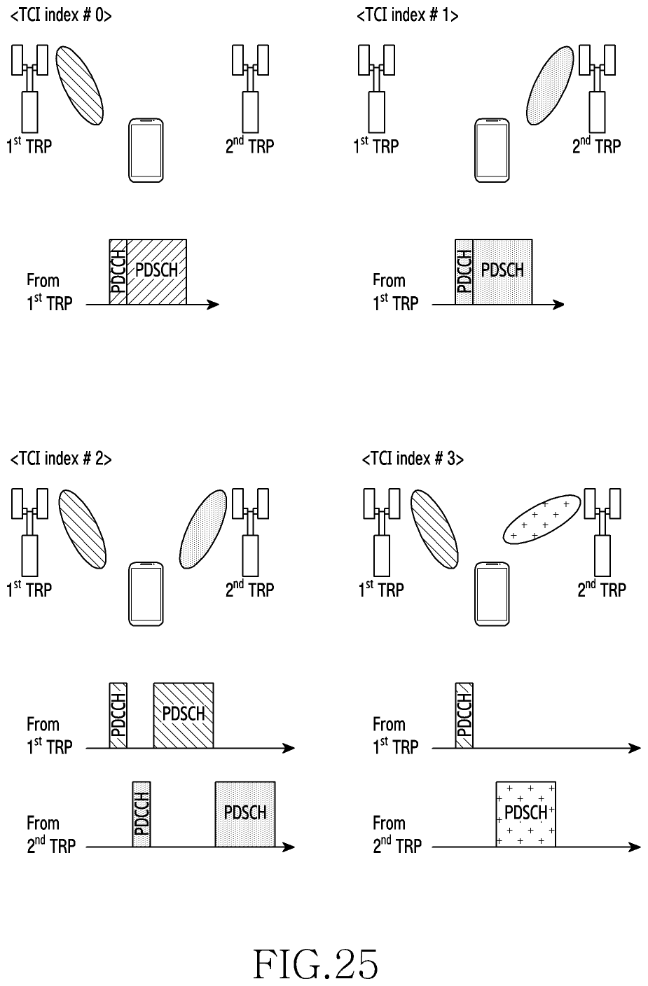

FIG. 24 may be an embodiment different from FIG. 22. As shown in FIG. 24, two or more TCI states that may be applied to beam control of a PDCCH may be simultaneously transmitted to a UE. In this case, the UE recognizes that an m-TRP operation for a PDCCH and switching between an s-TRP operation for a PDCCH and the m-TRP operation may be indicated through DCI, as shown in FIG. 25.

Specifically, referring to FIG. 24, a base station may configure a TCI index through a TCI codepoint 2410 in DCI. The TCI index may indicate a TCI State.

For example, TCI index #0 2420 may indicate TCI State #0 2430. TCI State #0 2230 corresponds to TCI State index #0 2431, and a TCI State according to TCI State index #0 may be applied to beam control of a PDCCH. TCI index #2 2440 may indicate TCI State #0 2430 and TCI State #1 2450. TCI State #1 2450 corresponds to TCI State index #1 2251, and a TCI State according to TCI State index #1 2251 may be applied to beam control of a PDCCH. That is, two or more TCI States that may be applied to beam control of a PDCCH may be simultaneously transmitted to the UE.

FIG. 25 illustrates a beam and TRP indication method by a UE operating in an m-TRP system, according to an embodiment of the disclosure.

FIG. 25 may be an embodiment different from FIG. 23. That is, unlike FIG. 23, which is an embodiment based on FIG. 22 in which two or more TCI states that may be applied to beam control of a PDCCH are not provided to a UE, FIG. 25 illustrates an embodiment based on FIG. 24 in which two or more TCI states that may be applied to beam control of a PDCCH are provided to a UE.

FIG. 25 illustrates an example of a beam and TRP indication method by a UE operating in an m-TRP system through the TCI index and TCI state configuration scheme of FIG. 23. FIG. 25 assumes a case where a TCI state indicating a beam of a PDCCH is configured or defined so as to also indicate TCI states of another channel and RS.

In the examples of FIGS. 24 and 25, when a UE receives a TCI index indicating two TCI states and applies the TCI index to PDSCH reception, the UE may identify that simultaneous or sequential PDSCH reception through two beams has been indicated. In addition, an operation in which each beam is transmitted from each TRP may also be indicated.

Both two TCI states may be indicated through one TCI index. In addition, when two TCI states are simultaneously indicated, both two TCI states that control a beam for a predetermined channel may be simultaneously indicated. Referring to FIG. 25, TCI index #12 2440 indicates both TCI State #0 2430 and TCI State #1 2450. Both TCI State #0 2430 and TCI State #1 2450 are TCI States that control a beam for a PDCCH.

In addition, FIG. 25 illustrates communication between a TRP and a UE according to the TCI codepoint of the DCI of FIG. 24. As in the example of FIG. 25, the TCI indexes of FIG. 24 indicate both two TCI States supporting beam control of a PDCCH, and thus an m-TRP (multi-TRP) operation of a PDSCH and switching between an s-TRP (single-TRP) operation and the m-TRP operation, and switching between an m-TRP operation of a PDCCH or an s-TRP operation of a PDCCH and the m-TRP operation may be indicated.

The above examples are examples of cases where in the case of configuring a TCI state, a base station configures two different TCI states, such as a TCI state used for beam control of both a PDCCH and a PDSCH, and a TCI state used only for beam control of a PDSCH. However, the disclosure is not limited thereto. That is, in addition to a PDSCH and a PDCCH, the base station may configure a TCI State in the same scheme for other channels such as a PUSCH and a PUCCH.

In addition, it is also possible to implement a method of not only indicating a TCI State used for beam control of both a PDCCH and a PDSCH and a TCI State used only for beam control of a PDSCH, but also indicating a TCI State used for beam control of both a PDSCH and a PUSCH and a TCI State used only for beam control of a PDSCH. That is, a method of indicating a TCI State according to the disclosure has no restrictions on the type of channel and a relationship between respective channels.

In other words, the disclosure is not limited to the above-described embodiments, and provides a method of configuring various types of TCI states such as a TCI state applied to beam control of all channels including a PDCCH and a TCI state applied to beam control of PDSCH and PUSCH channels, and a method of configuring a TCI index and a TCI codepoint for indicating each channel beam control in a combination of various TCI states.

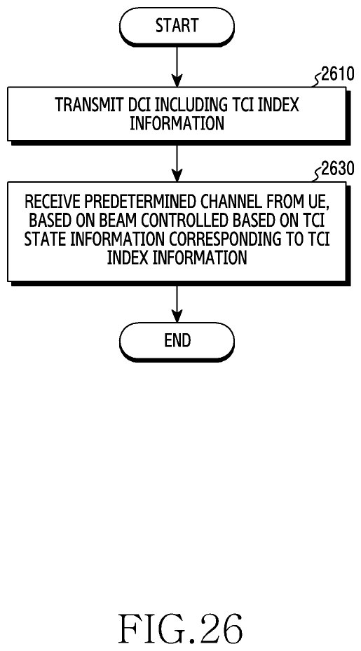

FIG. 26 illustrates an operation of a base station according to an embodiment of the disclosure.

According to an embodiment of the disclosure, in operation 2610, a base station may transmit DCI including TCI index information to a UE.

According to an embodiment of the disclosure, TCI state information may include information on at least one of a target channel and a target reference signal (RS) on which beam control is to be performed based on the TCI state information.

According to an embodiment of the disclosure, the TCI state information may be applied to beam control of another channel or another RS other than the target channel or the target RS according to a configuration of the base station. For example, the base station may configure TCI state information applied to beam control of a PDCCH to be used for beam control of a PDSCH.

According to an embodiment of the disclosure, the base station may provide, to the UE, information on a relationship between at least one of the target channel or the target RS and at least one of another channel or another RS. For example, the base station may provide, to the UE, information on a relationship between at least one of the target channel or the target RS and at least one of another channel or another RS through at least one of DCI and TCI state information.

The disclosure is not limited to the above example, and the base station may provide, to the UE, information on a relationship between at least one of the target channel or the target RS and at least one of another channel or another RS through higher layer signaling.

According to an embodiment of the disclosure, TCI state information in which a first control channel or a demodulation reference signal (DMRS) of the first control channel is configured as the target channel or the target RS may also be used for beam control of a second control channel or a DMRS of the second control channel. For example, TCI state information in which a PDCCH or a DMRS of the PDCCH is configured as the target channel or the target RS may also be used for beam control of a PUCCH or a DMRS of the PUCCH.

According to an embodiment of the disclosure, the TCI index information may include first TCI state information and second TCI state information. That is, the TCI index information may include multiple pieces of TCI state information.

In addition, according to an embodiment of the disclosure, when the first TCI state information is applicable to beam control of a first channel, and the second TCI state information is not applicable to beam control of the first channel, the base station may be unable to configure the UE to receive the first channel from multiple base stations.

For example, the base station may configure a first TCI index for the UE. When the first TCI index includes a first TCI state and a second TCI state, and the first TCI state is applicable to beam control of a PDCCH, but the second TCI state is not applicable to beam control of a PDCCH, the base station is unable to indicate the UE to receive a PDCCH from multiple base stations. That is, the base station is unable to indicate the UE to switch between an m-TRP operation of a PDCCH or an s-TRP operation of a PDCCH and the m-TRP operation. The above embodiment may be applied not only to a PDCCH, but also to all channels such as PUCCHs, PDSCHs, and PUSCHs, and applied to all RSs.

According to an embodiment of the disclosure, when the first TCI state information and the second TCI state information are applicable to beam control of a first channel, the base station is able to configure the UE to receive the first channel from multiple base stations.

For example, the base station may configure a first TCI index for the UE. When the first TCI index includes a first TCI state and a second TCI state, and both the first TCI state and the second TCI state are applicable to beam control of a PDCCH, the base station may indicate the UE to receive a PDCCH from multiple base stations. That is, the base station may indicate the UE to switch between an m-TRP operation of a PDCCH or an s-TRP operation of a PDCCH and the m-TRP operation. The above embodiment may be applied not only to a PDCCH, but also to all channels such as PUCCHs, PDSCHs, and PUSCHs, and applied to all RSs.

In operation 2630, the base station may receive a predetermined channel from the UE, based on a beam controlled based on TCI state information corresponding to the TCI index information.

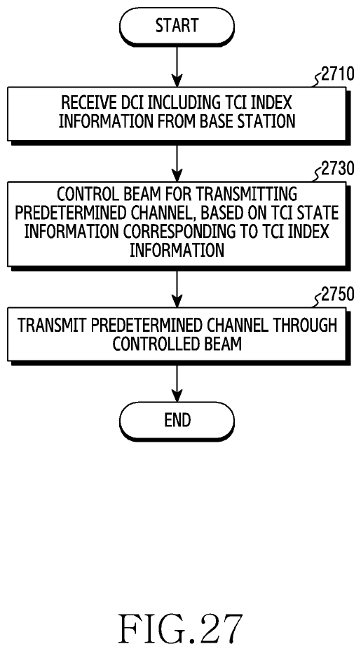

FIG. 27 illustrates an operation of a UE according to an embodiment of the disclosure.

According to an embodiment of the disclosure, in operation 2710, a UE may receive DCI including TCI index information from a base station.

In operation 2730, the UE may control a beam for transmitting a predetermined channel, based on TCI state information corresponding to the TCI index information.

According to an embodiment of the disclosure, the TCI state information may include information on at least one of a target channel and a target reference signal (RS) on which beam control is to be performed based on the TCI state information.

According to an embodiment of the disclosure, the TCI state information may be applied to beam control of another channel or another RS other than the target channel or the target RS according to a configuration of the base station.

According to an embodiment of the disclosure, the UE may receive, from the base station, information on a relationship between at least one of the target channel or the target RS and at least one of another channel or another RS.

According to an embodiment of the disclosure, TCI state information in which a first control channel or a demodulation reference signal (DMRS) of the first control channel is configured as the target channel or the target RS may also be used for beam control of a second control channel or a DMRS of the second control channel. Since this corresponds to what has been previously described, detailed description thereof will be omitted.

According to an embodiment of the disclosure, the TCI index information may include first TCI state information and second TCI state information. When the first TCI state information is applicable to beam control of a first channel, and the second TCI state information is not applicable to beam control of the first channel, the base station may be unable to configure the UE to receive the first channel from multiple base stations.

In addition, according to an embodiment of the disclosure, when the first TCI state information and the second TCI state information are applicable to beam control of a first channel, the base station is able to configure the UE to receive the first channel from multiple base stations. Since this corresponds to what has been previously described, detailed description thereof will be omitted.

In operation 2750, the UE may transmit a predetermined channel through the controlled beam.

FIG. 28 illustrates a structure of a UE according to embodiments of the disclosure.

Referring to FIG. 28, the UE may include a transceiver, which refers to a UE receiver 2801 and a UE transmitter 2802 as a whole, a memory (not illustrated), and a UE processor 2803 (or UE controller or processor). The UE transceiver 2801 and 2802, the memory, and the UE processor 2803 may operate according to the above-described communication methods of the UE. Components of the UE are not limited to the above-described example. For example, the UE may include a larger or smaller number of components than the above-described components. Furthermore, the UE processor 2803, the UE transmitter 2802, the UE receiver 2801, and the memory may be implemented in the form of a single chip. The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver. In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories, and the memory may store instructions for performing the above-described communication methods.

Furthermore, the UE processor may control a series of processes such that the UE can operate according to the above-described embodiments. For example, the UE processor 2803 may transmit DCI including TCI index information to the UE, and receive a predetermined channel from the UE, based on a beam controlled based on TCI state information corresponding to the TCI index information. The UE processor 2803 may include multiple processors, and the UE processor 2803 may perform operations of controlling the components of the UE by executing programs stored in the memory.

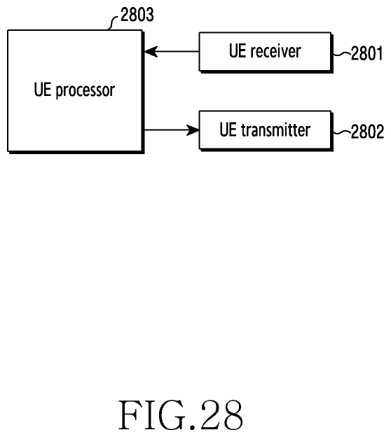

FIG. 29 illustrates a structure of a base station according to embodiments of the disclosure.

Referring to FIG. 29, the base station may include a transceiver, which refers to a base station receiver 2801 and a base station transmitter 2802 as a whole, a memory (not illustrated), and a base station processor 2803 (or base station controller or processor). The base station transceiver 2801 and 2802, the memory, and the base station processor 2803 may operate according to the above-described communication methods of the base station. However, components of the base station are not limited to the above-described example. For example, the base station may include a larger or smaller number of components than the above-described components. Furthermore, the base station transmitter 2802, the base station receiver 2801, the memory, and the base station processor 2803 may be implemented in the form of a single chip. According to an embodiment of the disclosure, the base station may a transmission and reception point (TRP).

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver. In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories, and the memory may store instructions for performing the above-described communication methods.

The base station processor 2803 may control a series of processes such that the base station can operate according to the above-described embodiments. For example, the base station processor 2803 may receive DCI including TCI index information from the base station, control a beam for transmitting a predetermined channel, based on TCI state information corresponding to the TCI index information, and transmit the predetermined channel through the controlled beam. The base station processor 2083 may include multiple processors, and the base station processor 2803 may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1-15. (canceled)

16. A method performed by a user equipment (UE) in a wireless communication system, the method comprising:
receiving, from a base station, information indicating a first transmission configuration indication (TCI) state and a second TCI state;
identifying, the first TCI state for receiving a physical downlink control channel (PDCCH) among the first TCI state and the second TCI state; and
receiving the PDCCH based on the first TCI state,
wherein the first TCI state is identified based on configuration information for the TCI state for the PDCCH.

17. The method of claim 16,
wherein the first TCI state and the second TCI state are indicated simultaneously, and
wherein the second TCI state is not utilized for receiving said PDCCH.

18. The method of claim 16,
wherein the first TCI state and the second TCI state are indicated based on a single index.

19. The method of claim 16,
wherein the first TCI state is enabled for receiving a physical downlink shared channel (PDSCH).

20. The method of claim 16, further comprising:
receiving, from the base station, configuration information regarding a plurality of TCI states via radio resource control (RRC) signaling.

21. A method performed by a base station in a wireless communication system, the method comprising:
transmitting, to a user equipment (UE), information indicating a first transmission configuration indication (TCI) state and a second TCI state; and
transmitting, to the UE, a physical downlink control channel (PDCCH) based on the first TCI state among the first TCI state and the second TCI state,
wherein the first TCI state is identified based on configuration information for the TCI state for the PDCCH.

22. The method of claim 21,
wherein the first TCI state and the second TCI state are indicated simultaneously, and
wherein the second TCI state is not utilized for receiving said PDCCH.

23. The method of claim 21,
wherein the first TCI state and the second TCI state are indicated based on a single index.

24. The method of claim 21,
wherein the first TCI state is enabled for receiving a physical downlink shared channel (PDSCH).

25. The method of claim 21, further comprising:
transmitting, to the UE, configuration information regarding a plurality of TCI states via radio resource control (RRC) signaling.

26. A user equipment (UE) in a wireless communication system, the UE comprising:
a transceiver; and
at least one processor coupled with the transceiver and configured to:
receive, from a base station, information indicating a first transmission configuration indication (TCI) state and a second TCI state,
identify, the first TCI state for receiving a physical downlink control channel (PDCCH) among the first TCI state and the second TCI state, and
receive the PDCCH based on the first TCI state,
wherein the first TCI state is identified based on configuration information for the TCI state for the PDCCH.

27. The UE of claim 26,
wherein the first TCI state and the second TCI state are indicated simultaneously, and
wherein the second TCI state is not utilized for receiving said PDCCH.

28. The UE of claim 26,
wherein the first TCI state and the second TCI state are indicated based on a single index.

29. The UE of claim 26,
wherein the first TCI state is enabled for receiving a physical downlink shared channel (PDSCH).

30. The UE of claim 26, wherein the at least one processor is further configured to:
receive, from the base station, configuration information regarding a plurality of TCI states via radio resource control (RRC) signaling.

31. A base station in a wireless communication system, the base station comprising:
a transceiver; and
at least one processor coupled with the transceiver and configured to:
transmit, to a user equipment (UE), information indicating a first transmission configuration indication (TCI) state and a second TCI state, and
transmit, to the UE, a physical downlink control channel (PDCCH) based on the first TCI state among the first TCI state and the second TCI state,
wherein the first TCI state is identified based on configuration information for the TCI state for the PDCCH.

32. The base station of claim 31,
wherein the first TCI state and the second TCI state are indicated simultaneously, and
wherein the second TCI state is not utilized for receiving said PDCCH.

33. The base station of claim 31,
wherein the first TCI state and the second TCI state are indicated based on a single index.

34. The base station of claim 31,
wherein the first TCI state is enabled for receiving a physical downlink shared channel (PDSCH).

35. The base station of claim 31, wherein the at least one processor is further configured to:
transmit, to the UE, configuration information regarding a plurality of TCI states via radio resource control (RRC) signaling.
